(19) United States
(12) Patent Application Publication
(10) Pub. No.: US 2024/0091712 A1
(43) Pub. Date: Mar. 21, 2024

(54) REVERSE OSMOSIS APPARATUS AND METHOD THEREOF

(71) Applicant: NANYANG TECHNOLOGICAL UNIVERSITY, Singapore (SG)

(72) Inventors: William Bernard KRANTZ, Singapore (SG); Tzyy Haur CHONG, Singapore (SG)

(21) Appl. No.: 17/767,814

(22) PCT Filed: Oct. 9, 2020
(86) PCT No.: PCT/SG2020/050579

§ 371 Date: Apr. 8, 2022

(30) Foreign Application Priority Data
Oct. 10, 2019 (SG) 10201909462T

(51) Int. Cl. B01D 63/16; B01D 61/02; B01D 61/08; B01D 63/02; B01D 63/08; C02F 1/38; C02F 1/44

(52) U.S. Cl. CPC B01D 63/16; B01D 61/025; B01D 61/08; B01D 63/02; B01D 63/082; C02F 1/38; C02F 1/441; B01D 2313/12; B01D 2313/143; B01D 2313/146; B01D 2313/243; B01D 2315/02; C02F 2103/08; C02F 2303/10

(57) ABSTRACT

A reverse osmosis apparatus including a reverse osmosis unit having a housing; a cylindrical drum rotatably disposed inside the housing wherein a lateral gap therebetween defines a intervening chamber, and including an outer cylindrical wall and an inner cylindrical wall to define an inner cylindrical feed chamber and an outer annular separation chamber therewithin; and at least one channeling structure defining a permeate channel extending radially from the inner cylindrical wall to the outer cylindrical wall, wherein a first channel end is closed and a second channel end opens into the intervening chamber. The at least one channeling structure including a membrane element extending lengthwise forming a semi-permeable interface between the permeate channel and a feed-flow-region in fluid communication with the inner cylindrical feed chamber. The apparatus including a pump to pressurize the inner cylindrical feed chamber, and a motor to rotate the cylindrical drum for generating centrifugal force.

### TECHNICAL FIELD

Various embodiments generally relate to a reverse osmosis apparatus and a reverse osmosis method of separating a solvent from a feed. In particular, various embodiments generally relate to a centrifugal reverse osmosis apparatus and a centrifugal reverse osmosis method of separating a solvent from a feed.

### BACKGROUND

The rate of increase in the demand for water during the 20^{th} century was more than twice that of the rate of population growth. As a result, 40% of the people in the world now live in areas subject to water stress, which is expected to reach 48% by 2025. In addition, pathogenic contaminants in the limited fresh water supply of the world now affect nearly 1 billion people and are projected to affect as many as 3.5 billion people by 2025. Although 70% of the earth is covered by water, only an estimated 0.008% of this water is accessible as fresh water to sustain the present world population of 7.7 billion people. This limited water supply is being compromised owing to pollution and contamination associated with increased industrial and agricultural use. Hence, increasing our available supply of fresh water is now a global concern.

Seawater or brackish water desalination via reverse osmosis (RO) has emerged as a technology for increasing the fresh water supply of the world. The International Desalination Association reported that in 2019 there were more than 20,000 desalination plants in the world supplying fresh water to 300 million people in 150 countries. However, reverse osmosis desalination is still an expensive source of fresh water. It costs from $0.66/m³ to $1.32/m³ to produce fresh water via reverse osmosis desalination in comparison to an average cost of $0.53/m³ for a direct source of fresh water. A major reason for the high cost of reverse osmosis desalination is the high pressure required to achieve a reasonable water recovery while overcoming the osmotic pressure differential (OPD) between saline water and fresh water. For example, for a typical seawater containing 35 g/L of salt producing a fresh water product containing 0.35 g/L of salt, the minimum transmembrane pressure (TMP) required to achieve a 50% total water recovery using conventional single-stage reverse osmosis (SSRO) is 55.5 bar.

Conventionally, the cost of reverse osmosis desalination can be reduced by increasing the applied pressure using more than one reverse osmosis stage, whereby the concentrate or retentate brine from the first reverse osmosis stage, that is, what does not pass through the membrane in the first reverse osmosis stage, is sent as feed to a second reverse osmosis stage. The combined permeate from both reverse osmosis stages is the fresh water product. Using two reverse osmosis stages in series reduces the specific energy consumption (SEC), the energy required per unit volume of fresh water product, by pumping only a portion of the saltwater feed up to the maximum pressure required for the desired water product recovery. Using three reverse osmosis stages in series will reduce the specific energy consumption further. However, using reverse osmosis stages in series requires a high-pressure booster pump between each reverse osmosis stage in series that adds to the fixed and maintenance costs, and process complexity. Optimum operation for saline water desalination usually involves using between one and three reverse osmosis stages in series. A variation on increasing the number of stages is done by the closed-circuit reverse osmosis process that in theory has an infinite number of stages. This is achieved in the closed-circuit reverse osmosis process by continuously recirculating the brine while progressively increasing the feed pressure as the concentration on the feed side of the membrane increases and continuously adding feed. However, closed-circuit reverse osmosis is a batch or semi-batch process rather than a continuous desalination process that is not readily adaptable or applicable to large-scale desalination. Further, closed-circuit reverse osmosis has deficiencies due to an entropy-mixing effect (i.e., the seawater feed is added to the system at the same rate as the permeate is withdrawn and mixed with the recirculated brine) as well as cumulative frictional losses due to recirculation.

Accordingly, there is a need for a more economical and efficient solution for performing reverse osmosis.

### SUMMARY

According to various embodiments, there is provided a reverse osmosis apparatus. The apparatus may include a reverse osmosis unit having a housing. The reverse osmosis unit may further include a cylindrical drum disposed inside the housing and coupled to the housing in a manner so as to be rotatable relative to the housing about a longitudinal axis of the cylindrical drum, wherein a lateral gap between an exterior cylindrical surface of the cylindrical drum and the housing defines an intervening chamber. The cylindrical drum may include an outer cylindrical wall defining an interior cylindrical space of the cylindrical drum, and an inner cylindrical wall partitioning the interior cylindrical space into an inner cylindrical feed chamber encircled by the inner cylindrical wall and an outer annular separation chamber between the inner cylindrical wall and the outer cylindrical wall. The reverse osmosis unit may further include at least one channeling structure extending radially from the inner cylindrical wall of the cylindrical drum to the outer cylindrical wall of the cylindrical drum and sub-dividing the outer annular separation chamber into at least a permeate channel and a feed-flow-region, the at least one channeling structure defining the permeate channel therewithin, wherein a first channel end of the at least one channeling structure at the inner cylindrical wall is closed to separate the permeate channel from the inner cylindrical feed chamber and a second channel end of the at least one channeling structure is opened through the outer cylindrical wall to open the permeate channel into the intervening chamber, wherein the inner cylindrical wall has an opening for direct fluid communication between the inner cylindrical feed chamber and the feed-flow-region of the outer annular separation chamber. The at least one channeling structure may include a membrane element extending lengthwise along the at least one channeling structure from the inner cylindrical wall of the cylindrical drum to the outer cylindrical wall of the cylindrical drum, the membrane element being a semi-permeable interface between the permeate channel and the feed-flow-region of the outer annular separation chamber. The apparatus may further include a pump in fluid communication with the inner cylindrical feed chamber of the cylindrical drum of the reverse osmosis unit, the pump operable to pressurize the inner cylindrical feed chamber to be equal to or higher than an osmotic pressure of a feed for reverse osmosis. The apparatus may further include a motor coupled to the cylindrical drum of the reverse osmosis unit, the motor operable to rotate the cylindrical drum so as to continuously increase, via a centrifugal force generated, a pressure of the feed in the feed-flow-region of the outer annular separation chamber along the membrane element with increasing distance from the inner cylindrical wall of the cylindrical drum to the outer cylindrical wall of the cylindrical drum.

According to various embodiments, there is provided a reverse osmosis method of separating a solvent from a feed. The method may include filling a cylindrical drum of a reverse osmosis unit of a reverse osmosis apparatus with the feed in a manner such that an inner cylindrical feed chamber of the cylindrical drum and a feed-flow-region of an outer annular separation chamber of the cylindrical drum is filled up with the feed. The reverse osmosis unit may include a housing. The reverse osmosis unit may further include the cylindrical drum disposed inside the housing and coupled to the housing in a manner so as to be rotatable relative to the housing about a longitudinal axis of the cylindrical drum, wherein a lateral gap between an exterior cylindrical surface of the cylindrical drum and the housing defines an intervening chamber. The cylindrical drum may include an outer cylindrical wall defining an interior cylindrical space of the cylindrical drum, and an inner cylindrical wall partitioning the interior cylindrical space into the inner cylindrical feed chamber encircled by the inner cylindrical wall and the outer annular separation chamber between the inner cylindrical wall and the outer cylindrical wall. The reverse osmosis unit may further include at least one channeling structure extending radially from the inner cylindrical wall of the cylindrical drum to the outer cylindrical wall of the cylindrical drum and sub-dividing the outer annular separation chamber into at least a permeate channel and the feed-flow-region, the at least one channeling structure defining the permeate channel therewithin, wherein a first channel end of the at least one channeling structure at the inner cylindrical wall is closed to separate the permeate channel from the inner cylindrical feed chamber and a second channel end of the at least one channeling structure is opened through the outer cylindrical wall to open the permeate channel into the intervening chamber, wherein the inner cylindrical wall has an opening for direct fluid communication between the inner cylindrical feed chamber and the feed-flow-region of the outer annular separation chamber. The at least one channeling structure may include a membrane element extending lengthwise along the at least one channeling structure from the inner cylindrical wall of the cylindrical drum to the outer cylindrical wall of the cylindrical drum, the membrane element being a semi-permeable interface between the permeate channel and the feed-flow-region of the outer annular separation chamber. The method may further include pressurizing, via a pump of the reverse osmosis apparatus in fluid communication with the inner cylindrical feed chamber of the cylindrical drum, the feed in the inner cylindrical feed chamber of the cylindrical drum and the feed-flow-region of the outer annular separation chamber of the cylindrical drum to be equal to or higher than an osmotic pressure of the feed for reverse osmosis. The method may further include rotating the cylindrical drum relative to the housing, via a motor of the reverse osmosis apparatus coupled to the cylindrical drum, to continuously increase, via a centrifugal force generated, a pressure of the feed in the feed-flow-region of the outer annular separation chamber along the membrane element with increasing distance from the inner cylindrical wall of the cylindrical drum to the outer cylindrical wall of the cylindrical drum

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1A shows a schematic diagram of a reverse osmosis apparatus for separating a solvent from a feed according to various embodiments;

FIG. 1B shows a schematic diagram of the reverse osmosis apparatus of FIG. 1A with an energy recovery unit (or energy recovery device, ERD) coupled to the reverse osmosis unit of FIG. 1A according to various embodiments;

FIG. 2A shows a perspective see-through view of a reverse osmosis apparatus according to various embodiments;

FIG. 2B shows side and top views of the reverse osmosis apparatus of FIG. 2A according to various embodiments;

FIG. 2C shows a cross-sectional view of the reverse osmosis apparatus along the A-A plane of the side view of FIG. 2B according to various embodiments;

FIG. 3A shows a schematic of a cylindrical drum of a reverse osmosis apparatus through which permeate channels extend to discharge permeate into an intervening chamber;

FIG. 3B shows a schematic of an inner arrangement of the cylindrical drum of the reverse osmosis apparatus of FIG. 3A incorporating three inner manifolds to increase the number of hollow fibers in the radial direction according to various embodiments;

FIG. 4 is a schematic of a feed channel, reverse osmosis membrane, and permeate channel in the cross-section of the reverse osmosis apparatus, such as a centrifugal reverse osmosis (CRO) module, according to various embodiments;

FIG. 5 shows pressure difference between the retentate discharge at R and the feed inlet at R₀ as a function of the water recovery that can be generated by the reverse osmosis apparatus for a typical seawater feed containing 35 g/L of salt;

FIG. 6 shows comparison of performance metrics for the reverse osmosis apparatus of the various embodiments (or centrifugal reverse osmosis, CRO) and single-stage reverse osmosis (SSRO) for a typical seawater feed containing 35 g/L of salt: (a) osmotic pressure differential (OPD) as a function of overall water recovery, (b) gross specific energy consumption (SEC_{gross}) and net specific energy consumption (SECₙₑₜ) as a function of overall water recovery;

FIG. 7 shows comparison of performance metrics for the reverse osmosis apparatus of the various embodiments (or CRO) and SSRO for a typical brackish saline water feed containing 10 g/L of salt: (a) OPD as a function of overall water recovery, (b) SEC as a function of overall water recovery CRO (solid line); and

FIG. 8 shows comparison of performance metrics for the reverse osmosis apparatus of the various embodiments (or CRO) and SSRO for a typical inland saline water feed containing 4 g/L of salt: (a) OPD as a function of the overall water recovery, (b) SEC as a function of overall water recovery.

### DETAILED DESCRIPTION

Embodiments described below in context of the apparatus are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right”, “front”, “lateral”, “side”, “up”, “down”, etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

Various embodiments generally relate to a reverse osmosis apparatus and a reverse osmosis method of separating a solvent from a feed. In particular, various embodiments generally relate to a centrifugal reverse osmosis apparatus and a centrifugal reverse osmosis method of separating a solvent from a feed. Various embodiments may be applicable for seawater or brackish water desalination via reverse osmosis to produce fresh water. According to various embodiments, the feed for reverse osmosis may include seawater or brackish water.

Various embodiments may include a reverse osmosis module or unit employing membrane elements, for example hollow fibre membranes or flat sheet membranes, which may be rotated around an axis-of-rotation to create a continuously increasing pressure in a radial direction owing to centrifugal acceleration of the feed, concentrate or retentate side of the membrane elements. According to various embodiments, this continuous increase in the pressure may be analogous to using an infinite number of reverse osmosis stages in series without the need for any inter-stage pumping. As such, it may significantly decrease the specific energy consumption (SEC) for desalination, ethanol concentration from aqueous solutions, and other membrane processes for separating a liquid from dissolved solutes.

According to various embodiments, the membrane element, e.g., the flat sheet membrane or the hollow fibre membrane, may be semi-permeable such that a solvent (e.g., water) in the feed may permeate through the membrane element, serving as a barrier or a wall, relative to one or more solutes (e.g., salt) contained in the solvent of the feed. In this manner, the solvent and the solutes may be separated to produce a solvent-rich permeate product (e.g., potable water) and a retentate product (e.g., brine) concentrated with the impermeable or relatively impermeable solutes. The permeation through the membrane element via reverse osmosis requires pressure on the feed or the retentate side of the membrane element. For a given feed concentration, the recovery of a reverse osmosis process depends on the transmembrane pressure (TMP) across the wall formed by the membrane element.

Conventionally, in large scale reverse osmosis operations, this pressure is created via conventional high-pressure mechanical pumps. These conventional mechanical pumps can increase the pressure of the feed up to the maximum transmembrane required for the desired recovery of the reverse osmosis in just one step (or one stage), or they can increase the pressure up to the maximum transmembrane pressure required for the desired recovery in two or more steps (two or more stages in series). Increasing the pressure in two or more steps or stages lowers the pumping energy requirement because it does not pump all the feed up to the maximum transmembrane pressure; that is, some permeation of the solvent will occur at pressures below the maximum transmembrane pressure required for the desired recovery. Accordingly, it is not necessary to pump all the feed up to the maximum transmembrane pressure required for the desired recovery since some permeation will occur at any pressure above the minimum transmembrane pressure dictated by the thermodynamic equilibrium between the feed or retentate side of the membrane element and the permeate side of the membrane element. Hence, pumping all the feed up to the required maximum transmembrane pressure for the desired recovery wastes energy. While increasing the pressure in two steps or stages may be more energy-efficient than increasing it in just one step or stage, and increasing the pressure in three steps or stages may be more energy-efficient than increasing it in two steps or stages, using reverse osmosis stages in series requires a high-pressure booster pump between each reverse osmosis stage in series that adds to the fixed and maintenance costs, and process complexity.

In comparison, various embodiments may increase the transmembrane pressure across the membrane element in differential or infinitesimal steps; this may be equivalent to using an infinite number of steps or stages to increase the pressure to the maximum transmembrane pressure required for the desired recovery of the reverse osmosis process. Hence, various embodiments may be far more energy-efficient than conventional reverse osmosis technology. According to various embodiments, the transmembrane pressure required for permeation may be increased in differential or infinitesimal steps or in a continuous manner by employing centrifugal force to increase the pressure on the feed or retentate side of the membrane element that extends from near the axis-of-rotation to the outer radius of the rotating device.

The essence of the various embodiments may be increasing the pressure in differential or infinitesimal steps or continuous manner by rotating a container or drum containing the membrane elements about the axis-of-rotation, which may also be the axis-of-symmetry of the reverse osmosis module or unit. Accordingly, various embodiments may make use of rotation of the container or drum containing the membrane elements to generate a centrifugal pressure via angular acceleration. Various embodiments have capitalized on the centrifugal pressure generated by angular acceleration that increases continuously with increasing radial distance from the axis-of-rotation for reverse osmosis. According to various embodiments, rotation of a properly configured container or drum containing the membrane elements about the axis-of-rotation may provide a way to continuously increase the transmembrane pressure within the container or drum as the feed flows radially through it, thereby approaching reverse osmosis at the thermodynamic restriction. Various embodiments may be a continuous process that may easily accommodate an energy-recovery device (ERD).

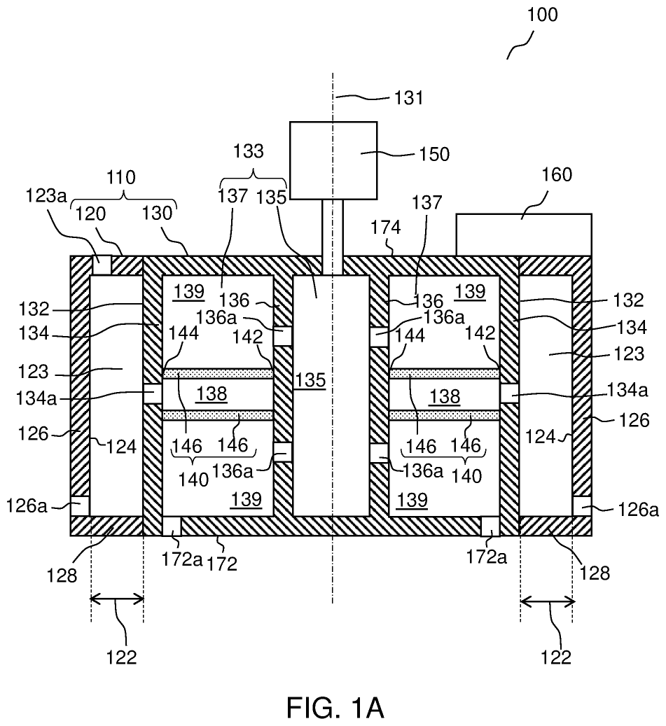

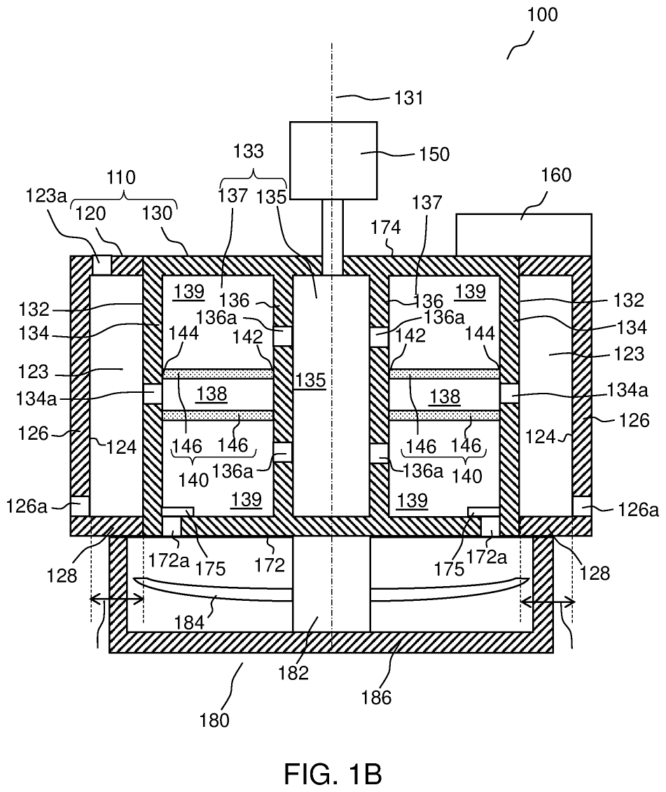

FIG. 1A shows a schematic diagram of a reverse osmosis apparatus 100 for separating a solvent from a feed according to various embodiments. According to various embodiments, the reverse osmosis apparatus 100 may be configured for reverse osmosis of a feed. The feed may include seawater, brackish water, or inland lower salinity water. Accordingly, the reverse osmosis apparatus 100 may be configured for reverse osmosis to produce portable water. According to various embodiments, the reverse osmosis apparatus 100 may include a reverse osmosis unit 110. Accordingly, the reverse osmosis process may be performed by the reverse osmosis unit 110. According to various embodiments, the reverse osmosis unit 110 may include a housing 120. The housing 120 may be an exterior casing of the reverse osmosis unit 110.

According to various embodiments, the reverse osmosis unit 110 may include a cylindrical drum 130 or container. According to various embodiments, the cylindrical drum 130 may be disposed inside the housing 120. According to various embodiments, the cylindrical drum 130 may be coupled to the housing 120 in a manner so as to be rotatable relative to the housing 120 about a longitudinal axis 131 of the cylindrical drum 130. According to various embodiments, the cylindrical drum 130 may be coupled to the housing 120 via one or more bearings, e.g. rotary bearings, ball bearings, roller bearings, lubricated plain bearing, etc., so as to be rotatable relative to the housing 120. According to various embodiments, the one or more bearings may be coaxial with respect to the longitudinal axis 131 of the cylindrical drum 130. Accordingly, the longitudinal axis 131 of the cylindrical drum 130 may be a rotational axis of the cylindrical drum 130.

According to various embodiments, the cylindrical drum 130 may be disposed inside the housing 120 and coupled to the housing 120 in a manner such that a lateral gap 122 between an exterior surface 132 of the cylindrical drum 130 and the housing 120, e.g., an interior surface 124 of the housing 120, defines an intervening chamber 123. The intervening chamber 123 may be an intervening space, an intervening gap or an interstice between the cylindrical drum 130 and the housing 120. Accordingly, a diameter of the cylindrical drum 130 may be smaller than a diameter or a width of the housing 120 such that a difference in size creates the lateral gap 122 defining the intervening chamber 123. According to various embodiments, the housing 120 may also serve as a safety barrier to isolate the rotating cylindrical drum 130. According to various embodiments, the intervening chamber 123 may also serve as a pass-through chamber, a flow-through chamber, or an intermediate chamber which fluid may continuously flow therethrough, or a holding chamber or a collection chamber for temporary holding of fluid before discharging.

According to various embodiments, the cylindrical drum 130 may include an outer cylindrical wall 134 defining an interior cylindrical space 133 of the cylindrical drum 130. Accordingly, the outer cylindrical wall 134 may provide a cylindrical structure or body or shape to the cylindrical drum 130. Hence the cylindrical drum 130 may be embodied by the outer cylindrical wall 134. Further, the cylindrical wall 134 may be an endless continuous wall forming a closed-loop circular shape which encloses the interior cylindrical space 133.

According to various embodiments, the cylindrical drum 130 may include an inner cylindrical wall 136. According to various embodiments, the inner cylindrical wall 136 may be concentric with the outer cylindrical wall 134. Accordingly, the inner cylindrical wall 136 and the outer cylindrical wall 134 may form concentric cylindrical structures. Further, a diameter of the inner cylindrical wall 136 may be smaller than the diameter of the outer cylindrical wall 134. Accordingly, the inner cylindrical wall 136 may be contained within the outer cylindrical wall 134. According to various embodiments, the inner cylindrical wall 136 may partition the interior cylindrical space 133 of the cylindrical drum 130 into an inner cylindrical feed chamber 135 encircled by the inner cylindrical wall 136 and an outer annular separation chamber 137 between the inner cylindrical wall 136 and the outer cylindrical wall 134. Accordingly, the inner cylindrical wall 136 may enclose and define the inner cylindrical feed chamber 135. Further, an annular space between the inner cylindrical wall 136 and the outer cylindrical wall 134 may define the outer annular separation chamber 137.

According to various embodiments, the reverse osmosis unit 110 may include at least one channeling structure 140 extending radially from the inner cylindrical wall 136 of the cylindrical drum 130 to the outer cylindrical wall 134 of the cylindrical drum 130. Accordingly, the at least one channeling structure 140 may be perpendicular to the longitudinal axis 131 of the cylindrical drum 130 and may be extending outwards from the inner cylindrical wall 136 of the cylindrical drum 130 to the outer cylindrical wall 134 of the cylindrical drum 130 along a radial direction with respect to the longitudinal axis 131 of the cylindrical drum 130. According to various embodiments, the at least one channeling structure 140 may sub-divide the outer annular separation chamber 137 into at least a permeate channel 138 and a feed-flow-region 139. Accordingly, the at least one channeling structure 140 may demarcate at least the permeate channel 138 and the feed-flow-region 139 within the outer annular separation chamber 137 of the cylindrical drum 130. According to various embodiments, the at least one channeling structure 140 may define the permeate channel 138 therewithin. Accordingly, the at least one channeling structure 140 may enclose or establish a boundary of the permeate channel 130.

According to various embodiments, a first channel end 142 of the at least one channeling structure 140 at the inner cylindrical wall 136 may be closed so as to separate the permeate channel 138 from the inner cylindrical feed chamber 135. Accordingly, the first channel end 142 of the at least one channeling structure 140 may be shut or blocked or obstructed such that the permeate channel 138 and the inner cylindrical feed chamber 135 may be severed from each other to cut off or be free of any direct fluid communication between the permeate channel 138 and the inner cylindrical feed chamber 135. For example, according to various embodiments, the first channel end 142 of the at least one channeling structure 140 may be coupled to a solid portion of the inner cylindrical wall 136. Accordingly, the solid portion of the inner cylindrical wall 136 may serve as a barrier or a closure structure to shut or block or obstruct the first channel end 142 of the at least one channeling structure 140.

According to various embodiments, a second channel end 144 of the at least one channeling structure 140 may be opened through the outer cylindrical wall 134 to open the permeate channel 138 into the intervening chamber 123. Accordingly, the permeate channel 138 and the intervening chamber 123 may be in direct fluid communication via a direct conduit or passage through the outer cylindrical wall 134. For example, according to various embodiments, the outer cylindrical wall 134 may include an opening 134a through which the at least one channeling structure 140 may be opened into the intervening chamber 123.

According to various embodiments, the inner cylindrical wall 136 may have an opening 136a for direct fluid communication between the inner cylindrical feed chamber 135 and the feed-flow-region 139 of the outer annular separation chamber 137. Accordingly, fluid may freely transfer from the inner cylindrical feed chamber 135 to the feed-flow-region 139 of the outer annular separation chamber 137.

According to various embodiments, the at least one channeling structure 140 may include a membrane element 146 or at least one membrane element 146 or one or more membrane elements 146. According to various embodiments, the membrane element 146 may include a flat sheet membrane or a hollow fibre membrane. According to various embodiments, the membrane element 146 may extend lengthwise along the at least one channeling structure 140 from the inner cylindrical wall 136 of the cylindrical drum 130 to the outer cylindrical wall 134 of the cylindrical drum 130. Accordingly, the membrane element 146 may extend in the radial direction with respect to the longitudinal axis 131 of the cylindrical drum 130 from the inner cylindrical wall 136 of the cylindrical drum 130 to the outer cylindrical wall 134 of the cylindrical drum 130.

According to various embodiment, the membrane element 146 may be a semi-permeable interface between the permeate channel 138 and the feed-flow-region 139 of the outer annular separation chamber 137. Accordingly, the membrane element 146 may allow the solvent in the feed to pass through the membrane element 146 from the feed-flow-region 139 to the permeate channel 138 when the feed-flow-region 139 is pressurized, while retaining a solute of the feed in the feed-flow-region 139. Hence, during operation of the reverse osmosis apparatus 100, a permeate product may be obtained in the permeate channel 138 and a retentate product, which is high in concentration of the solute, may remain in the feed-flow-region 139 along the membrane element 146.

According to various embodiments, the reverse osmosis apparatus 100 may include a pump 150. According to various embodiments, the pump 150 may be in fluid communication with the inner cylindrical feed chamber 135 of the cylindrical drum 130 of the reverse osmosis unit 110. The pump 150 may pump the feed along a feed line into the inner cylindrical feed chamber 135 of the cylindrical drum 130. According to various embodiments, the pump 150 may be operable to pressurize the inner cylindrical feed chamber 135 to be equal to or higher than an osmotic pressure of the feed for reverse osmosis. According to various embodiments, the pump 150 may pump the feed to fill up the inner cylindrical feed chamber 135 as well as the feed-flow-region 139 of the outer annular separation chamber 137, and continue pumping to pressurize the feed in the inner cylindrical feed chamber 135 and the feed-flow-region 139 of the outer annular separation chamber 137 to be equal to or higher than the osmotic pressure of the feed for reverse osmosis. According to various embodiments, the osmotic pressure of the feed for reverse osmosis may correspond to a thermodynamic equilibrium between the feed and the permeate product, whereby no solvent permeation across the membrane element 146 may occur at pressures less than this thermodynamic equilibrium pressure. In other words, solvent permeation across the membrane element 146 may only occur at pressure equal to or higher than the osmotic pressure of the feed for reverse osmosis. According to various embodiments, the pump 150 may include a high-pressure pump. According to various embodiments, the feed in the inner cylindrical feed chamber 135 and the feed-flow-region 139 of the outer annular separation chamber 137 may be pre-pressurized via the pump 150 to a minimum pressured required to initiate permeation, for example the osmotic pressure (e.g. 28.0 Bar for the 35 g/L feed in FIG. 5). The pre-pressurization of the feed to the minimum pressure required to initiate permeation may optimise the reverse osmosis apparatus 100 such that the subsequent effect of the angular acceleration to increase the centrifugal pressure due to a rotation of the cylindrical drum 130 may be fully utilised for permeation to occur along an entire length of the membrane element 146 extending radially from the inner cylindrical wall 136 to the outer cylindrical wall 134.

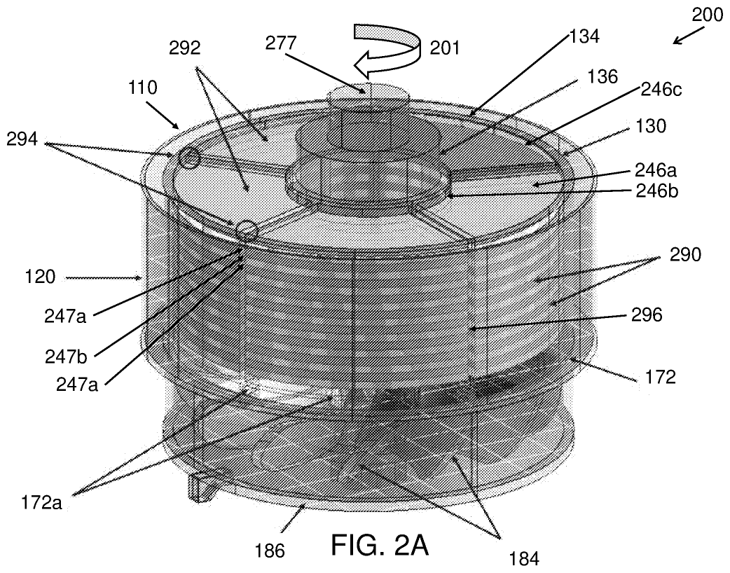

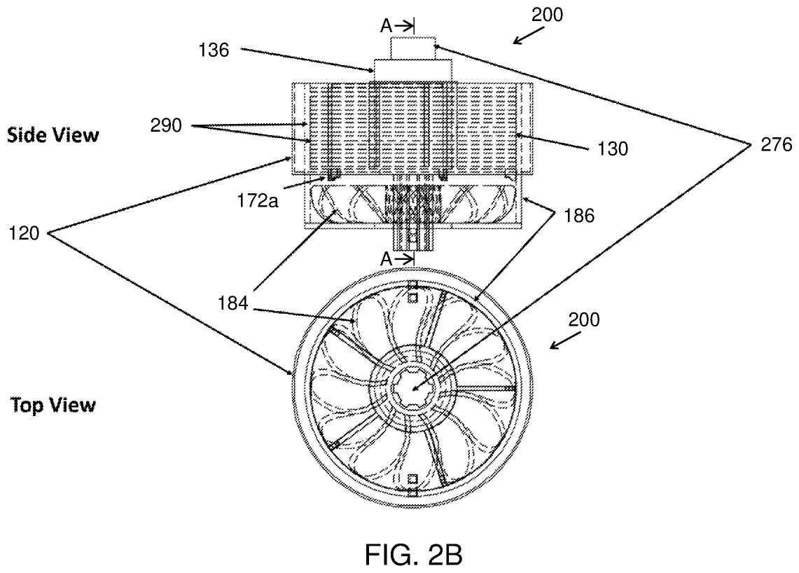

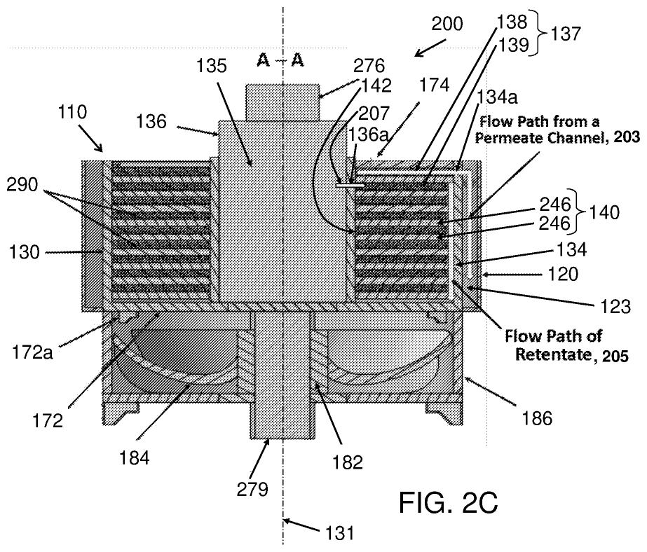

According to various embodiments, the reverse osmosis apparatus 100 may include a motor 160. According to various embodiments, the motor 160 may be coupled to the cylindrical drum 130 of the reverse osmosis unit 110. According to various embodiments, the motor 160 may be coupled to the cylindrical drum 130 in a manner so as to drive a rotation of the cylindrical drum 130 about its longitudinal axis 131. For example, according to various embodiments, the motor 160 may be coupled to the cylindrical drum 130 via a transmission mechanism including, but not limited to, a gear transmission, shaft transmission, a belt transmission, a chain transmission, or a rotor (for example see 276 of FIG. 2B, 2C, 3A).

According to various embodiments, the motor 160 may be operable to rotate the cylindrical drum 130 so as to continuously increase, via a centrifugal force generated, a pressure of the feed in the feed-flow-region 139 of the outer annular separation chamber 137 along the membrane element 146 with increasing distance from the inner cylindrical wall 136 of the cylindrical drum 130 to the outer cylindrical wall 134 of the cylindrical drum 130. Accordingly, the motor 160 may rotate the cylindrical drum 130 to generate a centrifugal force within the cylindrical drum 130. The centrifugal force generated may cause the pressure of the feed in the feed-flow-region 139 of the outer annular separation chamber 137 to continuously increase with respect to a radial distance from the rotational axis, which is the longitudinal axis 131, of the cylindrical drum 130. Accordingly, the further away from the longitudinal axis 131 of the cylindrical drum 130 in the radial direction, the higher the resultant pressure. Therefore, the pressure of the feed along the membrane element 146 in the radial direction with respect from the longitudinal axis 131 of the cylindrical drum 130 may increase in a continuous manner from the inner cylindrical wall 136 of the cylindrical drum 130 to the outer cylindrical wall 134 of the cylindrical drum 130. According to various embodiments, owing to the centrifugal pressure created in the feed-flow-region 139 by the rotation of the cylindrical drum 130, water permeation occurring at the osmotic pressure that progressively increases as the feed on the high-pressure side of the membrane element 146 becomes more concentrated owing to the water permeation. According to various embodiments, since the permeate channel 138 opens into the intervening chamber 123, the centrifugal force due to the rotation of the cylindrical drum 130 may not cause any similar increase in pressure in the permeate channel 138.

According to various embodiments, to capitalize the continuous increase of the pressure in the radial direction of the cylindrical drum 130 for reverse osmosis, the membrane element 146 may be stretched as long as possible along the radial direction and within the cylindrical drum 130. Accordingly, the inner cylindrical wall 136 of the cylindrical drum 130 be dimensioned to have a diameter as small as possible so as to be as close to the longitudinal axis 131 of the cylindrical drum 130 as possible. For example, according to various embodiments, a diameter of the outer cylindrical wall 134 of the cylindrical drum 130 may be equal to or greater than two times a diameter of the inner cylindrical wall 136 of the cylindrical drum 130. As a further example, according to various embodiments, the diameter of the outer cylindrical wall 134 of the cylindrical drum 130 may be equal to two, or three, or four, or five, or six times a diameter of the inner cylindrical wall 136 of the cylindrical drum 130.

According to various embodiments, the reverse osmosis unit 110 may include a permeate discharge port 126a. According to various embodiments, the permeate discharge port 126a may be disposed at the housing 120 in a manner so as to be in fluid communication with the intervening chamber 123 for discharging the permeate product at ambient pressure. According to various embodiments, the intervening chamber 123 may include a vent port 123a for venting the intervening chamber 123 to the atmosphere. According to various embodiments, since the permeate channel 138 opens into the intervening chamber 123, the permeate product in the permeate channel 138 obtained through reverse osmosis across the membrane element 146 may freely transfer from the permeate channel 138 into the intervening chamber 123 through the outer cylindrical wall 134. The permeation through the membrane element 146 near the inner cylindrical wall 136 of the cylindrical drum 130 creates the small pressure required to move the permeate product along the permeate channel 138 from the inner cylindrical wall 136 of the cylindrical drum 130 towards the outer cylindrical wall 134 of the cylindrical drum 130 and through the outer cylindrical wall 134 of the cylindrical drum 130, for example via the opening 134a, into the intervening chamber 123. From the intervening chamber 123, the permeate product may be discharged through the permeate discharge port 126a. According to various embodiments, the flow of the permeate product from the permeate channel 138 through the intervening chamber 123 and out from the permeate discharge port 126a may be a continuous process. According to various embodiments, the permeate discharge port 126a may include, but not limited to, an opening, a port, a nozzle, a tap, a conduit, a passage, etc. in the housing 120 for discharging the permeate product. For example, according to various embodiments, the permeate discharge port 126a may be at a wall 126 of the housing 120 and located at a bottom portion of the wall 126 towards a base 128 of the housing 120. As another example, according to various embodiments, the permeate discharge port 126a may be at the base 128 of the housing 120.

According to various embodiments, the reverse osmosis unit 110 may include one or more retentate discharge nozzles 172a. According to various embodiments, the one or more retentate discharge nozzles 172a may be disposed at a base 172 of the cylindrical drum 130 in a manner so as to be in fluid communication with the feed-flow-region 139 of the outer annular separation chamber 137 for discharging the retentate product. The base 172 may be opposite a top 174 of the cylindrical drum 130, whereby the base 172 and the top 174 form two opposite ends of the cylindrical drum 130. Accordingly, the retentate product may freely flow from the feed-flow-region 139 of the outer annular separation chamber 137 to the one or more retentate discharge nozzles 172a for discharging. For example, according to various embodiments, the one or more retentate discharge nozzles 172a may be coupled to the base 172 of the cylindrical drum 130 so as to directly connect to the feed-flow-region 139 of the outer annular separation chamber 137 for discharging the retentate product. As another example, according to various embodiments, the reverse osmosis unit 110 may include one or more retentate lines for directing retentate product near the outer cylindrical wall 134 of the cylindrical drum 130 towards the one or more retentate discharge nozzles 172a at the base 172 of the cylindrical drum 130. According to various embodiments, the one or more retentate discharge nozzles 172a may be disposed at the base 172 of the cylindrical drum 130 towards its perimeter so as to be close to the outer cylindrical wall 134 of the cylindrical drum 130.

According to various embodiments, as an example, two parallel annular membrane sheets may be arranged one above the other within the outer annular separation chamber 137 to stretch from the inner cylindrical wall 136 to the outer cylindrical wall 134 so as to form the at least one channeling structure 140, whereby the permeate channel 138 is sandwiched therebetween. Accordingly, the at least one channeling structure 140 may include the two annular membrane sheets extending radially from the inner cylindrical wall 136 to the outer cylindrical wall 134, whereby the permeate channel 138 is sandwiched therebetween. According to various embodiments, as another example, the at least one channeling structure 140 may include two parallel annular sector shaped membrane sheets arranged one above the other and at least two strips of permeate channel spacers respectively running between two opposing pairs of straight sides of the two annular sector shaped membrane sheets which extends from the inner cylindrical wall 136 to the outer cylindrical wall 134. Accordingly, the permeate channel 138 may be enclosed by the two annular sector shaped membrane sheets and the at least two strips of permeate channel spacers. According to various embodiments, as yet another example, the at least one channeling structure 140 may include a hollow fibre membrane. Accordingly, a lumen of the hollow fibre membrane may define the permeate channel 138.

FIG. 1B shows a schematic diagram of the reverse osmosis apparatus 100 of FIG. 1A with an energy recovery unit 180 (or energy recovery device, ERD) coupled to the reverse osmosis unit 110 according to various embodiments. The energy recovery unit 180 may be configured to recover pressure energy of the retentate product discharged from the one or more retentate discharge nozzle 172a. According to various embodiments, the energy recovery unit 180 may include a stationary hub 182 and a support structure 186. According to various embodiments, the support structure 186 may be fixedly coupled to the housing 120 of the reverse osmosis unit 110. For example, according to various embodiments, the support structure 186 may be fixedly coupled to the base 128 of the housing 120 of the reverse osmosis unit 110. According to various embodiments, the stationary hub 182 may be fixedly coupled to the housing 120 of the reverse osmosis unit 110 via the support structure 186. Accordingly, the stationary hub 182 may be fixed with respect to the housing 120 of the reverse osmosis unit 110. Hence, the stationary hub 182 may not be movable relative to the housing 120 of the reverse osmosis unit 110. According to various embodiments, the stationary hub 182 may be firmly attached or securely fastened to the support structure 186 such that the cylindrical drum 130 may rotate relative to the stationary hub 182. According to various embodiments, the stationary hub 182 may be aligned to the longitudinal axis 131 of the cylindrical drum 130. Accordingly, the cylindrical drum 130 may rotate about the longitudinal axis 131 of the cylindrical drum 130 while the stationary hub 182 may remain stationary along the longitudinal axis 131 of the cylindrical drum 130. According to various embodiments, the cylindrical drum 130 may be rotatably coupled to the stationary hub 182. For example, according to various embodiments, the base 172 of the cylindrical drum 130 may be rotatably coupled to the stationary hub 182.

According to various embodiments, the energy recovery unit 180 may include a plurality of stationary vanes 184 extending radially from the stationary hub 182. According to various embodiments, the plurality of stationary vanes 184 and the stationary hub 182 may form a fan-like structure. Since the stationary hub 182 is fixed relative to the housing 120 of the reverse osmosis unit 110, the plurality of stationary vanes 184 is also fixed with respect to the housing 120 of the reverse osmosis unit 110. According to various embodiments, the plurality of stationary vanes 184 may be fixedly coupled to the support structure 186. According to various embodiments, the fan-like structure formed by the plurality of stationary vanes 184 and the stationary hub 182 may have a diameter equal or greater than a diameter of the cylindrical drum 130. According to various embodiments, the one or more retentate discharge nozzles 172a at the base 172 of the cylindrical drum 130 may be directed towards the plurality of stationary vanes 184. According to various embodiments, for example, the one or more retentate discharge nozzles 172a may be angled or directed such that a discharge axis of the one or more retentate discharge nozzles 172a may be in a direction opposite to a rotational direction of the cylindrical drum 130. Further, each of the plurality of stationary vanes 184 may have a profile whereby impingement of jets of the retentate product discharged from the one or more retentate discharge nozzles 172a on the plurality of stationary vanes 184 may generate a torque on the base 172 of the cylindrical drum 130 in its rotational direction so as to augment the rotation of the cylindrical drum 130 in the rotational direction. Accordingly, the retentate product discharged from the one or more retentate discharge nozzles 172a may convert the pressure energy of the jet of retentate product into kinetic energy that in turn may be converted into a force acting on the plurality of stationary vanes 184 which may result in a reactive force that augments the rotation of the cylindrical drum 130 in the rotational direction. According to various embodiments, the retentate product may than be collected and/or discharged from the energy recover unit 180 for further treatment or disposal.

FIG. 2A, to FIG. 2C show a reverse osmosis apparatus 200 that uses flat sheet membranes 246 according to various embodiments. FIG. 2A shows a perspective see-through view of the reverse osmosis apparatus 200 according to various embodiments. FIG. 2B shows side and top views of the reverse osmosis apparatus 200 according to various embodiments. FIG. 2C shows a cross-sectional view of the reverse osmosis apparatus along the A-A plane of the side view of FIG. 2B according to various embodiments. According to various embodiments, the reverse osmosis apparatus 200 is provided to illustrate an example of the reverse osmosis apparatus 100 of FIG. 1A and FIG. 1B whereby the flat sheet membranes 246 are being used as the membrane element 146 of the at least one channeling structures 140 of the reverse osmosis apparatus 100. Accordingly, the reverse osmosis apparatus 200 includes all the features and limitations of the reverse osmosis apparatus 100 of FIG. 1A and FIG. 1B and is described below with the same reference characters referring to the same/common parts throughout.

According to various embodiments, the reverse osmosis apparatus 200 that employs flat sheet membranes 246 (e.g. see FIG. 2C) may be rotated about the longitudinal axis 131 of the cylindrical drum 130 (or axis-of-rotation or axis-of-symmetry). Accordingly, the reverse osmosis apparatus 200 may include the cylindrical drum 130 (or inner rotating cylindrical container) with the top 174 (or a top circular solid plate) and the base 172 (or a bottom circular plate) that rotates within the housing 120 (or an outer stationary cylindrical container) of the reverse osmosis unit 110. According to various embodiments, an inner cylindrical assembly, which includes the cylindrical drum 130 and the flat sheet membranes 246, may be rotated by a rotor 276 attached to the motor 160 (for example the motor 160 in FIG. 1A and FIG. 1B). As shown in FIG. 2A, the arrow 201 may denote a clockwise rotation when viewed from the top of the reverse osmosis apparatus 200. According to various other embodiments, a counter-clockwise rotation when viewed from the top of the reverse osmosis apparatus 200 may also be possible.

Referring to FIG. 2A, according to various embodiments, a feed (e.g., saline water) may be fed from a top of a hollow tube 277 located on the longitudinal axis 131 of the cylindrical drum 130 of the reverse osmosis apparatus 200 (or axis-of-rotation or axis-of-symmetry) into the inner cylindrical feed chamber 135 of the cylindrical drum 130. Referring to FIG. 2C, according to various other embodiments, the feed may also be fed from a bottom of a hollow tube 279 located on the longitudinal axis 131 of the cylindrical drum 130 of the reverse osmosis apparatus 200 (or axis-of-rotation or axis-of-symmetry) into the inner cylindrical feed chamber 135 of the cylindrical drum 130. According to various embodiments, the feed (e.g., saline water) may enters the inner cylindrical feed chamber 135 within the inner cylindrical wall 136 (or a manifold) of the cylindrical drum 130 that distributes the feed to the feed-flow-regions 139 of an outer separation chamber 137 (or feed channels) of the cylindrical drum 130 between the flat sheet membranes 246 that may be rigidly attached to the inner cylindrical wall 136 (or the manifold) of the cylindrical drum 130. According to various embodiments, the feed line may be coupled to hollow tube 277, 279 and/or the inner cylindrical feed chamber 135 of the cylindrical drum 130 via a swivel joint, or a swivel coupling, or a rotating coupling, etc.

According to various embodiments, the flat sheet membranes 246 may include annular flat sheet membranes arranged in a parallel stack 290, wherein inner arcs (or inner edges) and outer arcs (or outer edges) of the annular flat sheet membranes may be connected to the inner cylindrical wall 136 (or the manifold) of the cylindrical drum 130 and the outer cylindrical wall 134 (or outer rim) of the cylindrical drum 130, respectively. According to various embodiments, each annular flat sheet membrane in the parallel stack 290 of flat sheet membranes 246 may have the feed-flow-region 139 (or feed channel) on one side/face and the permeate channel 138 on an opposite side/face (other side/face). According to various embodiments, the parallel stack 290 may form a ‘sandwich’ of the flat sheet membranes 246, the feed-flow-regions 139 (or feed channels) with spacers (e.g., feed-flow channel spacers 247b in FIG. 2A), and the permeate channels 138 with spacers (e.g. permeate channel spacers 247a in FIG. 2A). According to various embodiments, the parallel stack 290 may have an alternating feed-flow region 139 (or feed channel) with spacers and permeate channel 138 with spacers whereby the flat sheet membranes 246 separates or partitions the feed-flow-regions 139 (or feed channels) and the permeate channels 138. According to various embodiments, the spacers (e.g., the permeate channel spacers 247a in FIG. 2A and the feed-flow channel spacers 247b in FIG. 2A) may be provided within the channels 138, 139 for maintaining adjacent annular flat sheet membranes at a pre-determined distance from each other (i.e., maintaining a pre-determined channel size) and for providing structural support for the channels 138, 139.

According to various embodiments, the feed-flow-regions 139 (or the feed channels) may be opened where they are attached to the inner cylindrical wall 136 (or the manifold) to permit the feed (e.g., saline water) to flow or pass into the feed-flow-region 139 (or the feed channel) between two adjacent flat sheet membranes 246 from the inner cylindrical feed chamber 135. According to various embodiments, the permeate channels 138 may be closed where they are attached to the inner cylindrical wall 136 (or the manifold). Accordingly, the solvent (e.g., water) that permeates through the flat sheet membranes 246 into the permeate channels 138 may flow through the permeate channels 138 that are open at the outer cylindrical wall 134 of the cylindrical drum 130 (or the outer rim of the inner rotating cylindrical container) into the intervening chamber 123.

FIG. 2C shows an example of the permeate flow path 203 from one of the permeate channels 138. According to various embodiments, the permeate product (e.g., potable water) may be discharged through the openings 134a (or ports) in the outer cylindrical wall 134 of the cylindrical drum 130 (or the outer rim of the inner rotating cylindrical container) and flows into the intervening chamber 123 of the housing 120 (or the annular region of the stationary outer container) from which it may be distributed at ambient pressure for use or further treatment. According to various embodiments, the retentate on the high-pressure side of the flat sheet membranes 246 may flow towards the outer cylindrical wall 134 of the cylindrical drum 130 (or the outer rim of the inner rotating cylindrical container).

According to various embodiments, the parallel stack 290 of ‘sandwich’ of the flat sheet membranes 246, the feed-flow-regions 139 (or feed channels) and permeate channels 138 may be divided into several annular sector sections 292 (or pie-shaped sections) in FIG. 2A. According to various embodiments, the sides of each annular sector sections 292 (or pie-shaped section) in FIG. 2A may be sealed except for small openings 294 in FIG. 2A (or through-hole or slot) on the sides, for example at outer ends of the spacers (e.g., feed-flow channel spacers 247b in FIG. 2A), of the feed-flow-regions 139 in FIG. 2C (or feed channels) near the outer cylindrical wall 134 of the cylindrical drum 130 (or the outer rim of the inner rotating cylindrical container), the locations for two of which are shown by the circles in FIG. 2A. The small openings 294 may permit the high-pressure retentate to flow downward in the small gap between adjacent annular sector sections 292 (or pie-shaped sections).

FIG. 2C shows the flow path 205 of the high-pressure retentate downward towards the base 172 (or lower circular plate) of the cylindrical drum 130. According to various embodiments, the high-pressure retentate may flow through a series of retentate discharge nozzles 172a (or nozzles) rigidly attached to the base 172 (or the lower circular plate) at the bottom of the cylindrical drum 130 (or inner rotating cylindrical container). According to various embodiments, the jets of retentate may impact on a series of stationary vanes 184 rigidly attached to the bottom of an annular region in the support structure 186 in the form of a stationary container, thereby creating a torque that serves to rotate the cylindrical drum 130 (or the inner rotating cylindrical container). In this manner, the pressure energy of the retentate product exiting the parallel stack 290 (or the membrane ‘sandwich’) may be converted into a kinetic energy of the jets that in turn is converted via impacting the stationary vanes 184 into a torque to rotate the cylindrical drum 130. According to various embodiments, in high-pressure applications such as seawater desalination, when the retentate product (e.g., concentrated brine) may be jetted through the retentate discharge nozzles 172a, its pressure may be reduced to the ambient pressure after which it is discharged for disposal or further processing through ports in the support structure 186 in the form of the stationary container containing the plurality of stationary vanes 184. According to various embodiments, in applications for which the retentate pressure is sufficiently high to justify using some type of energy recovery device (ERD) such as desalination of seawater, the retentate discharge nozzles 172a may serve to maintain the required back-pressure. According to various embodiments, in applications involving a lower retentate pressure such as desalination of brackish or inland water for which an energy recovery device (ERD) is not cost-effective, the back-pressure regulator 175 (for example see FIG. 1B) may be installed on the retentate discharge line to maintain the pressure of the retentate. The cylindrical drum 130 that is connected to the hollow tube 276, 279 located on the axis-of-rotation (axis-of-symmetry) may rotate within two or more bearings that allow the cylindrical drum 130 to rotate relative to the stationary concentric annular containers (e.g., the housing 120 and the support structure 186 in the form of the stationary container) for receiving and discharging the permeate product (e.g., potable water) and for receiving and discharging the ambient-pressure retentate product (e.g., concentrated brine).

Referring to FIG. 2A to FIG. 2C, according to various embodiments, the at least one channeling structure 140 (for example see FIG. 2C) of the reverse osmosis apparatus 200 may include an annular sector shaped membrane sheet 246a in FIG. 2A. According to various embodiments, an inner arc 246b of the annular sector shaped membrane sheet 246a may be coupled to the inner cylindrical wall 136 of the cylindrical drum 130 and an outer arc 246c of the annular sector shaped membrane sheet 246a may be coupled to the outer cylindrical wall 134 of the cylindrical drum 130. Accordingly, the annular sector shaped membrane sheet 246a may extend in the radial direction from the inner cylindrical wall 136 of the cylindrical drum 130 to the outer cylindrical wall 134 of the cylindrical drum 130.

According to various embodiments, the at least one channeling structure 140 of the reverse osmosis apparatus 200 may include two annular sector shaped membrane sheets 246a (or at least two annular sector shaped membrane sheets 246a or two or more annular sector shaped membrane sheets 246a) in a stack arrangement one above the other. According to various embodiments, the at least one channeling structure 140 of the reverse osmosis apparatus 200 may include at least two strips of permeate channel spacers 247a between the two annular sector shaped membrane sheets 246a to space apart the two annular sector shaped membrane sheets 246a. According to various embodiments, the at least two strips of permeate channel spacers 247a may be respectively lined between two opposing pairs of straight sides of the two annular sector shaped membrane sheets 246a in a manner such that a space enclosed by the two annular sector shaped membrane sheets 246a and the at least two strips of permeate channel spacers 247a may define the permeate channel 138 in FIG. 2C. Accordingly, with the two annular sector shaped membrane sheets 246a spaced apart one over the other, the two straight sides of each annular sector shaped membrane sheet 246a may be opposing that of the other annular sector shaped membrane sheet 246a. The at least two strips of permeate channel spacers 247a may then respectively join the two straight sides of a first of the two annular sector shaped membrane sheets 246a to that of a second of the two annular sector shaped membrane sheets 246a. Accordingly, the at least two strips of permeate channel spacers 247a may respectively seal the two straight sides of the two spaced apart annular sector shaped membrane sheets 246a. According to various embodiments, the at least one channeling structure 140 having the two annular sector shaped membrane sheets 246a and the at least two strips of permeate channel spacers 247a may be of an annular sector shaped or may be an annular sector shaped channeling structure 140.

According to various embodiments, a portion of the inner cylindrical wall 136 of the cylindrical drum 130 bordered around by the inner arcs 246b of the two annular sector shaped membrane sheets 246a and inner ends of the at least two strips of permeate channel spacers 247a may be a solid portion to close the first channel end 142 of the at least one channeling structure 140. Accordingly, the solid portion of the inner cylindrical wall 136 may serve as a barrier or a closure structure to shut or block or obstruct the first channel end 142 (see for example FIG. 2C) of the at least one channeling structure 140. Hence, the permeate channel 138 in FIG. 2C defined by the two annular sector shaped membrane sheets 246a and the at least two strips of permeate channel spacers 247a may be shut or blocked off or cut off or be free of any direct fluid communication with the inner cylindrical feed chamber 135.

According to various embodiments, a portion of the outer cylindrical wall 134 of the cylindrical drum 130 bordered around by the outer arcs 246c of the two annular sector shaped membrane sheets 246a and outer ends of the at least two strips of permeate channel spacers 247a may include the opening 134a to open the second channel end 144 of the at least one channeling structure 140 into the intervening chamber 123. Accordingly, the permeate channel 138 in FIG. 2C, which is defined by the by the two annular sector shaped membrane sheets 246a and the at least two strips of permeate channel spacers 247a, and the intervening chamber 123 may be in direct fluid communication via the opening 134a through the outer cylindrical wall 134 of the cylindrical drum 130.

According to various embodiments, the reverse osmosis apparatus 200 may include at least two (or two or more) annular sector shaped channeling structures 140 in a stack arrangement one above the other. Accordingly, the at least two annular sector shaped channeling structures 140 may form the parallel stack 290. According to various embodiments, the reverse osmosis apparatus 200 may include at least two strips of feed-flow channel spacers 247b between the at least two annular sector shaped channeling structures 140 to space apart the at least two annular sector shaped channeling structures 140. According to various embodiments, the at least two strips of feed-flow channel spacers 247b may be respectively lined along two opposing pairs of straight edges of the at least two annular sector shaped channeling structures 140 in a manner such that a space enclosed by the at least two annular sector shaped channeling structures 140 and the at least two strips of feed-flow channel spacers 247b may define the feed-flow-region 139 (or feed channel) in FIG. 2C. Accordingly, with the at least two annular sector shaped channeling structures 140 spaced apart one over the other, the two straight edges of a first of the at least two annular sector shaped channeling structures 140 may be opposing to corresponding straight edges of a second of the at least two annular sector shaped channeling structures 140. The at least two strips of feed-flow channel spacers 247b may then respectively join the two straight edges of the first of the at least two annular sector shaped channeling structures 140 to the corresponding opposing straight edges of the second of the at least two annular sector shaped channeling structures 140. Accordingly, the at least two strips of feed-flow channel spacers 247b may respectively seal the two straight sides of the at least two spaced apart annular sector shaped channeling structures 140.

According to various embodiments, a portion of the inner cylindrical wall 136 of the cylindrical drum 130 bordered around by two opposing inner arc edges of the at least two annular sector shaped channeling structures 140 and inner ends of the at least two strips of feed-flow channel spacers 247b may include the opening 136a for direct fluid communication between the inner cylindrical feed chamber 135 and the feed-flow-region 139 (or feed channel). Flow path 207 shows the flow from the inner cylindrical feed chamber 135 to the feed-flow-region 139 (or feed channel). Accordingly, the feed-flow-region 139 (or the feed channel) and the inner cylindrical feed chamber 135 may be in direct fluid communication via the opening 136a through the inner cylindrical wall 136 of the cylindrical drum 130.

According to various embodiments, a portion of the outer cylindrical wall 134 of the cylindrical drum 130 bordered around by two opposing outer arc edges of the at least two annular sector shaped channeling structures 140 and outer ends of the at least two strips of feed-flow channel spacers 247b may be a solid portion to separate the feed-flow-region 139 (or the feed channel) in FIG. 2C and the intervening chamber 123. Accordingly, the solid portion of the outer cylindrical wall 134 may serve as a barrier or a closure structure to shut or block or obstruct the feed-flow-region 139 (or the feed channel) from the intervening chamber 123. Hence, the feed-flow-region 139 (or the feed channel) may be shut or blocked off or cut off or be free of any direct fluid communication with the intervening chamber 123.

According to various embodiments, the reverse osmosis apparatus 200 may include a plurality of the annular sector shaped channeling structures 140 stacked in the arrangement as described so as to form alternating permeate channel 138 and feed-flow-region 139 (or feed channel) in FIG. 2C within a single stack.

According to various embodiments, each of the at least two strips of feed-flow channel spacers 247b may include the openings 294 (or through-hole or slot) at the outer end. According to various embodiments, the reverse osmosis apparatus 200 may include at least two adjacent stacks of annular sector shaped channeling structures 140 (or two adjacent parallel stacks 290), each stack having the at least two annular sector shaped channeling structures 140 in the stack arrangement. According to various embodiments, the at least two adjacent stacks of annular sector shaped channeling structures 140 may be spaced angularly from each other with respect to the longitudinal axis 131 of the cylindrical drum 130 in a manner so as to form a vertical retentate channel 296 in FIG. 2A parallel to the longitudinal axis 131 of the cylindrical drum 130 therebetween. Accordingly, the vertical retentate channel 296 in FIG. 2A may be a space or a gap between two adjacent stacks of annular sector shaped channeling structures 140. According to various embodiments, the vertical retentate channel 296 may extend along an entire length of the cylindrical drum 130. According to various embodiments, the through-holes 294 at the outer ends of the at least two strips of feed-flow channel spacers 247b may open the feed-flow-region 139 in FIG. 2C for direct fluid communication with the vertical retentate channel 296 in FIG. 2A. Accordingly, as the feed moves in the radial direction in the feed-flow-region 139 such that the solvent permeates into the permeate channel 138, the feed along the annular sector shaped membrane sheets 246a in FIG. 2A may transform into the retentate product as it approaches the outer cylindrical wall 134 of the cylindrical drum 130. Hence, the retentate product may than flow into the retentate channel 296 through the through-holes 294 at the outer ends of the at least two strips of feed-flow channel spacers 247b. From the retentate channel 296, the retentate product may then be discharged via the one or more retentate discharge nozzles 172a.

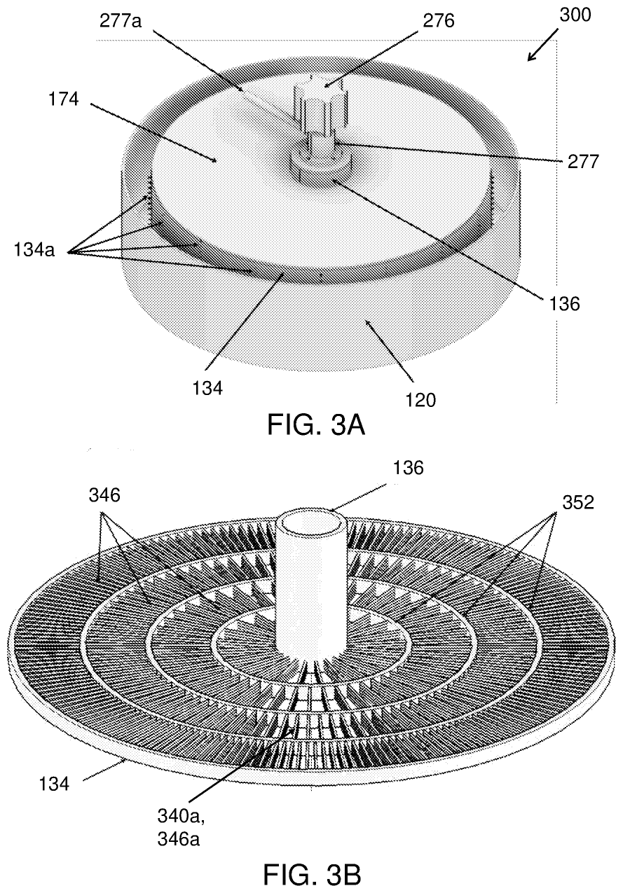

According to various embodiments, a reverse osmosis apparatus 300 that uses hollow fibre membranes 346 may operate in a manner like that of the reverse osmosis apparatus 200 of FIG. 2A to FIG. 2C that uses flat sheet membranes 246. FIG. 3A is a perspective view of the reverse osmosis apparatus 300 with the hollow fibre membranes 346 according to various embodiments. FIG. 3B shows an example of an arrangement of the hollow fibre membranes 346 for the reverse osmosis apparatus 300 according to various embodiments. According to various embodiments, the reverse osmosis apparatus 300 is provided to illustrate an example of the reverse osmosis apparatus 100 of FIG. 1A and FIG. 1B whereby the hollow fibre membranes 346 are being used as the membrane element 146 of the at least one channeling structures 140 of the reverse osmosis apparatus 100. Accordingly, the reverse osmosis apparatus 300 includes all the features and limitations of the reverse osmosis apparatus 100 of FIG. 1A and FIGS. 1B and 1s described below with the same reference characters referring to the same/common parts throughout.

According to various embodiments, in the reverse osmosis apparatus 300, an assembly of the hollow fibre membranes 346 may be rotated about the longitudinal axis 131 of the cylindrical drum 130 (or the axis-of-rotation or the axis-of-symmetry) via the rotor 276 that may be driven by the motor 160 (for example the motor 160 in FIG. 1A and FIG. 1B). The array of hollow fibre membranes 346 may be contained within the cylindrical drum 130 (or the rotating cylindrical container) that includes the outer cylindrical wall 134, the top 174 and the base 172 (or the outer rim, the top and the bottom cylindrical plates). According to various embodiments, the feed (e.g., saline water) may, similar to the reverse osmosis apparatus 200, enter the hollow tube 277 located on the longitudinal axis 131 of the cylindrical drum 130 (or the axis-of-rotation or the axis-of-symmetry) via a pipe 277a. FIG. 3A shows, according to various embodiments, the rotor 276 and the feed entering at the top of the reverse osmosis apparatus 300. According to various other embodiments, the rotor 276 and/or the feed may enter at the bottom of the reverse osmosis apparatus 300. According to various embodiments, the feed may flow from the hollow tube 277 into the inner cylindrical feed chamber 135 within the inner cylindrical wall 136 (or the manifold) of the cylindrical drum 130 that distributes the feed to the outside of the inner cylindrical wall 136 into the array of hollow fibre membranes 346. According to various embodiments, the hollow fibre membranes 346 may be closed at their ends that are attached to the inner cylindrical wall 136 (or the manifold) of the cylindrical drum 130 but may be opened at their other ends, for example via the opening 134a in the outer cylindrical wall 134, that may extend through the outer cylindrical wall 134 (or outer rim) of the cylindrical drum 130 (or the outer rim of the rotating cylindrical container). According to various embodiments, the solvent (e.g., water) may permeate from the outside through the walls of the hollow fibre membranes 346 into the lumen of the hollow fibre membranes 346 and then flow through the hollow fibre membranes 346 to be discharged at their open end into the intervening chamber 123 of the housing 120 (or the concentric stationary cylindrical container). Accordingly, the permeate product (e.g., potable water) may be discharged at ambient pressure in the same way as described for the reverse osmosis apparatus 200 that uses the flat sheet membranes 246. According to various embodiments, the concentrated retentate (e.g., brine) may be discharged through a series of jets fixed attached to the base 172 of the cylindrical drum 130 (or the bottom circular plate of the rotating assembly) in the same way as described for the reverse osmosis apparatus 200 that uses flat sheet membranes 246. According to various embodiments, this may serves as the energy recovery device (ERD) whereby the pressure energy of the concentrated retentate may be converted into the kinetic energy of the jets that in turn may be converted via the stationary vanes 184 in FIG. 2A and FIG. 2B into a torque to rotate the cylindrical drum 130.

According to various embodiments, the reverse osmosis apparatus 300 with using hollow fibre membranes 346 in the cylindrical drum 130 (or the rotating device) may result in an increase in the spacing between the hollow fibre membranes 346 around the circumference of the cylindrical drum 130 with an increase in radial distance from the longitudinal axis 131 of the cylindrical drum 130 (or the axis-of-rotation or the axis-of-symmetry). FIG. 3B shows the arrangement of hollow fibre membranes 346 for the reverse osmosis apparatus 300 for improving the efficiency on the use of the volume of the cylindrical drum 130 (or the rotating device). According to various embodiments, by employing one or more additional annular frames 352 (or additional manifolds) located concentrically between the inner cylindrical wall 136 (or the manifold) and the outer cylindrical wall 134 (or the outer rim) of the cylindrical drum 130 with respect to the longitudinal axis 131 of the cylindrical drum 130 (or the axis-of-rotation or the axis-of-symmetry), the arrangement may minimise or mitigate any decrease in hollow fibre density around the circumference of the cylindrical drum 130 and any associated decrease in a liquid velocity on the feed or retentate side with increasing radial distance from the longitudinal axis 131 of the cylindrical drum 130 (or the axis-of-rotation or the axis-of-symmetry). The arrangement may also minimize or mitigate concentration polarization, scaling and fouling with increasing radius, as well as prevent the concentrate or retentate concentration to increase owing to the solvent permeating through the hollow fibre membranes 346, which may otherwise progressively concentrate the retentate. Accordingly, the arrangement may prevent a progressive decrease with increasing radial distance from longitudinal axis 131 of the cylindrical drum 130 (or the axis-of-rotation or the axis-of-symmetry) of the ratio of the membrane area to the cross-sectional area for flow of the concentrate or retentate solution. According to various embodiments, there may be more hollow fibre membranes 346 exiting from each additional annular frame 352 (or additional manifold) than entries to the additional annular frame 352 (or additional manifold). For example, as shown in FIG. 3B, the reverse osmosis apparatus 100 with three additional annular frames 352 (or additional manifolds) additional annular frame 352 (or additional manifold) may allow an eight-fold increase in the number of hollow fibre membranes 346 from the inner cylindrical wall 136 (or the manifold) to the outer cylindrical wall 134 (or the outer rim) of the cylindrical drum 130.

According to various embodiments, the at least one channeling structure 140 of the reverse osmosis apparatus 300 may include the hollow fibre membrane 346 as the membrane element. According to various embodiments, the inner end of the hollow fibre membrane 346 may be coupled to the inner cylindrical wall 136 of the cylindrical drum 130 and the outer end of the hollow fibre membrane 346 may be coupled to the outer cylindrical wall 134 of the cylindrical drum 130. Accordingly, the hollow fibre membrane 346 may extend radially from the inner cylindrical wall 136 of the cylindrical drum 130 to the outer cylindrical wall 134 of the cylindrical drum 130. According to various embodiments, the lumen of the hollow fibre membrane 346 may define the permeate channel 138. According to various embodiments, the reverse osmosis apparatus 300 may include a plurality of hollow fibre membranes 346 extending radially from the inner cylindrical wall 136 of the cylindrical drum 130 to the outer cylindrical wall 134 of the cylindrical drum 130. Accordingly, the reverse osmosis apparatus 300 may include a plurality of permeate channels 138 extending radially from the inner cylindrical wall 136 of the cylindrical drum 130 to the outer cylindrical wall 134 of the cylindrical drum 130.

According to various embodiments, a portion of the inner cylindrical wall 136 of the cylindrical drum 130 encircled by an orifice of the inner end of the hollow fibre membrane 346 may be a solid portion to close the first channel end 142 in FIG. 1A of the at least one channeling structure 140. Accordingly, the solid portion of the inner cylindrical wall 136 may serve as a barrier or a closure structure to shut or block or obstruct the first channel end 142 of the at least one channeling structure 140 or a first end of the lumen of the hollow fibre membrane 346. Hence, the permeate channel 138 defined by the lumen of the hollow fibre membrane 346 may be shut or blocked off or cut off or be free of any direct fluid communication with the inner cylindrical feed chamber 135.

According to various embodiments, a portion of the outer cylindrical wall 134 of the cylindrical drum 130 encircled by an orifice of the outer end of the hollow fibre membrane 346 may include the opening 134a in FIG. 1A to open the second channel end 144 of the at least one channeling structure 140 into the intervening chamber 123. Accordingly, the permeate channel 138 defined by the lumen of the hollow fibre membrane 346 and the intervening chamber 123 may be in direct fluid communication via the opening 134a through the outer cylindrical wall 134 of the cylindrical drum 130.

According to various embodiments, in the reverse osmosis apparatus 300, the cylindrical drum 130 may further include the annular frame 352 in FIG. 3B disposed inside the outer separation chamber 137 in FIG. 1A to surround the inner cylindrical wall 136 in a concentric manner with a first annular space between the inner cylindrical wall 136 and the annular frame 352 and a second annular space between the annular frame 352 and the outer cylindrical wall 134. Accordingly, the annular frame 352 may have a diameter larger than that of the inner cylindrical wall 136 and smaller than that of the outer cylindrical wall 134 in FIG. 3B. Hence, the inner cylindrical wall 136, the annular frame 352 and the outer cylindrical wall 134 may be spaced apart in sequence from each other in a concentric manner with respect to the longitudinal axis 131 of the cylindrical drum 130. According to various embodiments, the hollow fibre membrane 346 extending between the inner cylindrical wall 136 and the outer cylindrical wall 134 may extend through the annular frame 352. For example, the annular frame 352 may include a through-hole which the hollow fibre membrane 346 may be inserted through or passed through such that the hollow fibre membrane 346 may extend continuously from the inner cylindrical wall 136 to the outer cylindrical wall 134.

According to various embodiments, the reverse osmosis apparatus 300 may include at least one secondary channeling structure 340a. The at least one secondary channeling structure 340a may include a secondary hollow fibre membrane 346a. According to various embodiments, an inner end of the secondary hollow fibre membrane 346a may be coupled to the annular frame 352 and an outer end of the secondary hollow fibre membrane 346a may be coupled to the outer cylindrical wall 134 of the cylindrical drum 130. Accordingly, the secondary hollow fibre membrane 346a may extend radially from the annular frame 352 to the outer cylindrical wall 134 of the cylindrical drum 130. According to various embodiments, a lumen of the secondary hollow fibre membrane 346a may define a secondary permeate channel. According to various embodiments, the reverse osmosis apparatus 300 may include a plurality of secondary hollow fibre membranes 346a extending radially from the annular frame 352 to the outer cylindrical wall 134 of the cylindrical drum 130. Accordingly, the reverse osmosis apparatus 300 may include a plurality of secondary permeate channels extending radially from annular frame 352 to the outer cylindrical wall 134 of the cylindrical drum 130.

According to various embodiments, the reverse osmosis apparatus 300 may include at least one annular frame 352, or one or more annular frames 352. For example, the reverse osmosis apparatus 300 may include one or two or three or four or more annular frames 352. According to various embodiments, each of the annular frames 352 may be disposed between the inner cylindrical wall 136 and the outer cylindrical wall 134 in a concentric manner. Accordingly, the inner cylindrical wall 136, each of the annular frame 352 and the outer cylindrical wall 134 may be spaced apart in a successive manner from each other in a concentric manner with respect to the longitudinal axis 131 of the cylindrical drum 130. According to various embodiments, the reverse osmosis apparatus 300 may include a set of secondary hollow fibre membranes 346a extending in a radial manner from each annular frame 352 to the outer cylindrical wall 134 of the cylindrical drum 130. Accordingly, when the reverse osmosis apparatus 300 has two or more annular frames 352, the reverse osmosis apparatus 300 may have two or more sets of secondary hollow fibre membranes 346a, wherein different sets of secondary hollow fibre membranes 346a may be of different length due to different distances respectively from the annular frame to the outer cylindrical wall 134 of the cylindrical drum 130.

According to various embodiments, a portion of the annular frame 352 in FIG. 3B encircled by an orifice of the inner end of the secondary hollow fibre membrane 346 may be a solid portion to close a first channel end of the at least one secondary channeling structure 340a. Accordingly, the solid portion of the annular frame 352 may serve as a barrier or a closure structure to shut or block or obstruct the first channel end of the at least one secondary channeling structure 340a or the inner end of the secondary hollow fibre membrane 346a. Hence, the secondary permeate channel defined by the lumen of the secondary hollow fibre membrane 346a may be shut or blocked off or cut off or be free of any direct fluid communication with the free-flow-region 139 in FIG. 1A via the inner end of the secondary hollow fibre membrane 346a.

According to various embodiments, a portion of the outer cylindrical wall 134 of the cylindrical drum encircled by an orifice of the outer end of the secondary hollow fibre membrane 346a may include the opening 134a in FIG. 3A to open a second channel end of the at least one secondary channeling structure 340a in FIG. 3B into the intervening chamber 123. Accordingly, the secondary permeate channel defined by the lumen of the secondary hollow fibre membrane 346a and the intervening chamber 123 may be in direct fluid communication via the opening 134a through the outer cylindrical wall 134 of the cylindrical drum 130.

According to various embodiments, in operation, the reverse osmosis apparatus 100, 200, 300 of the various embodiments may perform the following reverse osmosis method of separating the solvent from the feed.

According to various embodiments, the reverse osmosis method may include filling the cylindrical drum 130 of the reverse osmosis unit 110 of the reverse osmosis apparatus 100, 200, 300 with the feed in a manner such that the inner cylindrical feed chamber 135 of the cylindrical drum 130 and the feed-flow-region 139 of the outer annular separation chamber 137 of the cylindrical drum 130 may be filled up with the feed. The reverse osmosis method may further include, pressurizing, via the pump 150 of the reverse osmosis unit 100, 200, 300 in fluid communication with the inner cylindrical feed chamber 135 of the cylindrical drum 130, the feed in the inner cylindrical feed chamber 135 of the cylindrical drum 130 and the feed-flow-region 139 of the outer annular separation chamber 137 of the cylindrical drum 130 to be equal to or higher than an osmotic pressure of the feed for reverse osmosis. According to various embodiments, the osmotic pressure of the feed for reverse osmosis may correspond to a thermodynamic equilibrium between the feed and the permeate product, whereby no solvent permeation across the membrane element 146, 246, 246a, 346, 346a may occur at pressures less than this thermodynamic equilibrium pressure. In other words, solvent permeation across the membrane element 146, 246, 246a, 346, 346a may only occur at pressure equal to or higher than the osmotic pressure of the feed for reverse osmosis. According to various embodiments, the reverse osmosis method may further include rotating the cylindrical drum 130 relative to the housing 120, via the motor 160 of the reverse osmosis apparatus 100, 200, 300 coupled to the cylindrical drum 130, to continuously increase, via a centrifugal force generated, a pressure of the feed in the feed-flow-region 139 of the outer annular separation chamber 137 along the membrane element 146, 246, 246a, 346, 346a with increasing distance from the inner cylindrical wall 136 of the cylindrical drum 130 to the outer cylindrical wall 134 of the cylindrical drum 130. Accordingly, the pressure may be increased in differential or infinitesimal steps or continuous manner in the radial direction along the membrane element 146, 246, 246a, 346, 346a, wherein this continuous increase in the pressure may be analogous to using an infinite number of reverse osmosis stages in series without the need for any inter-stage pumping.

According to various embodiments, the reverse osmosis method may further include discharging the permeate product containing the solvent at ambient pressure via the permeate discharge port 126a in FIG. 1A disposed at the housing 120 and in fluid communication with the intervening chamber 123.

According to various embodiments, the reverse osmosis method may further include maintaining the pressure of the feed in the feed-flow-region 139 of the outer annular separation chamber 137 via at least the back-pressure regulator 175 (see for example FIG. 1B) of the reverse osmosis unit 110 coupled between the feed-flow-region 139 of the outer annular separation chamber 137 and the one or more retentate discharge nozzles 172a disposed at the base 172 of the cylindrical drum 130. According to various embodiments, the back-pressure regulator 175 may be along a flow line between the feed-flow-region 139 of the outer annular separation chamber 137 and the one or more retentate discharge nozzles 172a.

According to various embodiments, the reverse osmosis method may further include discharging the retentate product from the feed-flow-region 139 of the outer annular separation chamber 137 towards the plurality of stationary vanes 184 in FIG. 1B extending radially from the stationary hub 182 fixed with respect to the housing 120 and aligned to the longitudinal axis 131 of the cylindrical drum 130 so as to recover a pressure energy from the retentate product to augment the motor 160 for rotating the cylindrical drum 130. According to various embodiments, impingement of jets of the retentate product discharged from the one or more retentate discharge nozzles 172a on the plurality of stationary vanes 184 may generate a torque on the base 172 of the cylindrical drum 130 in its rotational direction so as to augment the rotation of the cylindrical drum 130 in the rotational direction.

The following present the proof-of-concept based on a mathematical model that predicts the performance metrics for the various embodiments that include the total product recovery and the specific energy consumption (SEC) or energy per unit volume of permeate product required. The proof-of-concept shows that various embodiments may significantly reduce the SEC relative to conventional technology to achieve the same permeate product recovery. This implies that various embodiments may achieve a higher permeate product recovery for operation at the same SEC as conventional technology. Specifically, the overall permeate water product recovery and SEC for desalination of feed solutions whose salt concentration ranges from 4000 ppm to 35000 ppm were determined. Various embodiments were shown to have a significantly lower SEC than conventional single-stage reverse osmosis (SSRO) for the same overall permeate water product recovery.

Obtaining the performance metrics requires determining the permeate and concentrate or retentate flowrates. These in turn may be determined from material balances on the overall liquid flow and on the dissolved salt in this liquid. The mathematical analysis is the same for both the hollow fibre membrane embodiment (i.e., the reverse osmosis apparatus 200) and the flat sheet membrane embodiment (i.e., the reverse osmosis apparatus 300).

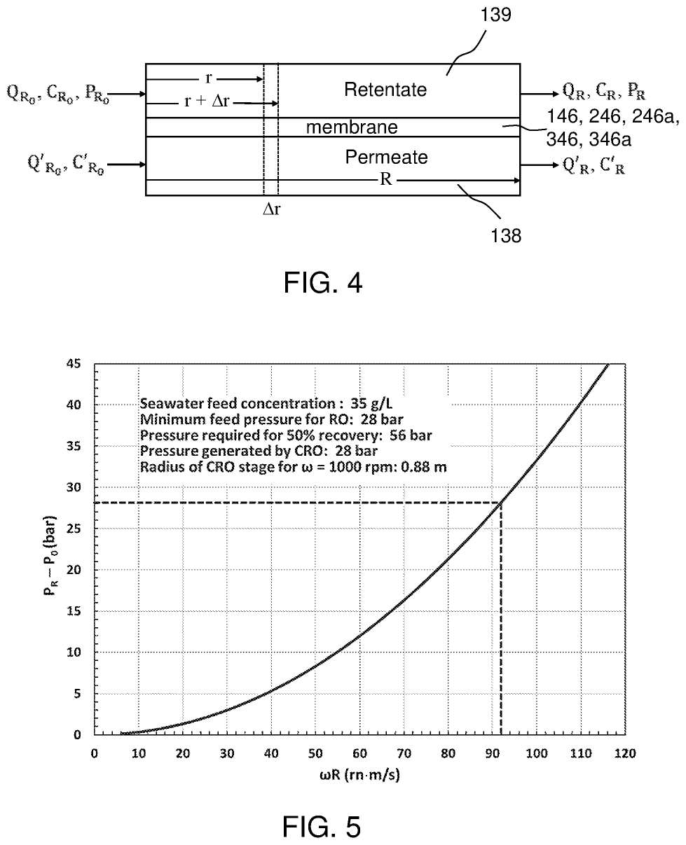

Considering an annular slice of the reverse osmosis apparatus 100, 200, 300 of the various embodiments having thickness H and a differential or incremental length Δr in the radial direction extending out from the axis-of-rotation as shown in FIG. 4. An overall material balance and material balance on the dissolved solute may be given by the following equations:

$${G}_{h} {\vert}_{r} + {G}_{l} {\vert}_{r} - {G}_{h} {\vert}_{r + Δ r} - {G}_{l} {\vert}_{r + Δ r} ⇒ - \frac{d ( {G}_{h} + {G}_{l} )}{d r} = 0 \qquad ( 1 )$$

$${C}_{h} {G}_{h} {\vert}_{r} + {C}_{l} {G}_{l} {\vert}_{r} - {C}_{h} {G}_{h} {\vert}_{r + Δ r} - {C}_{l} {G}_{l} {\vert}_{r + Δ r} ⇒ - \frac{d ( {C}_{h} {G}_{h} + {C}_{l} {G}_{l} )}{d r} = 0 \qquad ( 2 )$$

where

$${G}_{h} {\vert}_{r}$$

is the volumetric flowrate and

$${C}_{h} {\vert}_{r}$$

is the solute concentration on the high-pressure concentrate or retentate side of the membranes (e.g., membrane element 146, 246, 246a, 346, 346a) at the upstream end of the annular slice of the reverse osmosis apparatus 100, 200, 300 of the various embodiments,

$${G}_{h} {\vert}_{r + Δ r}$$

is the volumetric flowrate and

$${C}_{h} {\vert}_{r + Δ r}$$

is the solute concentration on the high-pressure concentrate or retentate side (e.g., feed-flow-region 139) of the membranes (e.g., membrane element 146, 246, 246a, 346, 346a) at the downstream end of the annular slice of the reverse osmosis apparatus 100, 200, 300 of the various embodiments,

$${G}_{l} {\vert}_{r}$$

is the volumetric flowrate and

$${C}_{l} {\vert}_{r}$$

is the solute concentration on the low-pressure or permeate side (e.g., permeate channel 138) of the membranes (e.g., membrane element 146, 246, 246a, 346, 346a) at the upstream end of the annular slice of the reverse osmosis apparatus 100, 200, 300 of the various embodiments, and

$${G}_{l} {\vert}_{r + Δ r}$$

is the volumetric flowrate and

$${C}_{l} {\vert}_{r + Δ r}$$

is the solute concentration on the low-pressure or permeate side (e.g., permeate channel 138) of the membranes (e.g., membrane element 146, 246, 246a, 346, 346a) at the downstream end of the annular slice of the reverse osmosis apparatus 100, 200, 300 of the various embodiments.

Equations (1) and (2) may constitute two first-order differential equations that require boundary conditions on the volumetric flowrate and solute concentration on the high-pressure concentrate or retentate side (e.g., feed-flow-region 139) of the membranes (e.g., membrane element 146, 246, 246a, 346, 346a), and on the volumetric flowrate and solute concentration on the low-pressure or permeate side (e.g., permeate channel 138) of the membranes (e.g., membrane element 146, 246, 246a, 346, 346a). These boundary conditions may be given by the following:

Gₕ=G_{f}, Cₕ=C_{f}, Gₗ=0, Cₗ=C_{f}(1−σ) at r=R₀ (3)

where G_{f} and C_{f} are the specified volumetric flowrate and solute concentration of the feed to the reverse osmosis apparatus 100, 200, 300 of the various embodiments, R₀ is the radius of the rotating cylindrical hollow tube (e.g., inner cylindrical feed chamber 135) located on the longitudinal axis 131 of the cylindrical drum 130 (or the axis-of-rotation or axis-of-symmetry), and σ is the solute rejection of the membranes (e.g., membrane element 146, 246, 246a, 346, 346a) used in the reverse osmosis apparatus 100, 200, 300 of the various embodiments defined by σ=(Cₕ−Cₗ)/Cₕ.

Equations (1) and (2) may be integrated to obtain the following:

$$- \frac{d ( {G}_{h} + {G}_{l} )}{d r} = 0 ⇒ {G}_{h} + {G}_{l} = {K}_{1} \qquad ( 4 )$$

$$- \frac{d ( {C}_{h} {G}_{h} + {C}_{l} {G}_{l} )}{d r} = 0 ⇒ {C}_{h} {G}_{h} + {C}_{l} {G}_{l} = {K}_{2} \qquad ( 5 )$$

where K₁ and K₂ are integration constants that can be determined from the boundary conditions given by Equation (3) and are given by the following:

K₁=G_{f} (6)

K₂=C_{f}G_{f} (7)

Substitute Equations (6) and (7) into Equations (1) and (2) to obtain

Gₕ+Gₗ=G_{f} (8)

CₕGₕ+CₗGₗ=C_{f}G_{f} (9)

The concentrations on the high-pressure concentrate or retentate side (e.g., feed-flow-region 139) of the membranes (e.g., membrane element 146, 246, 246a, 346, 346a) and on the low-pressure permeate side (e.g. permeate channel 138) of the membranes (e.g., membrane element 146, 246, 246a, 346, 346a) may be determined by the centrifugal pressure at the radial distance from the longitudinal axis 131 of the cylindrical drum 130 (or the axis-of-rotation or axis-of-symmetry). In this analysis, a process-design at the thermodynamic restriction was considered. The process-design at the thermodynamic restriction implies operation at a transmembrane pressure (TMP), i.e., the pressure difference across a membrane, equal to that determined by the thermodynamic equilibrium between the liquid on the high-pressure concentrate or retentate side (e.g., feed-flow-region 139) of the membranes (e.g., membrane element 146, 246, 246a, 346, 346a) and the liquid on the low-pressure permeate side (e.g., permeate channel 138) of the membranes (e.g., membrane element 146, 246, 246a, 346, 346a). It was shown that designing desalination processes based on the thermodynamic limit is reasonable. The high flux reverse osmosis membranes permit operating at a TMP only slightly above the thermodynamic restriction. The small pressure decrease owing to flow through the system and to cause permeation through the membranes may not be considered in the process-design at the thermodynamic restriction.

The centrifugal pressure generated at a radius r in an annular system having an inner radius R₀, outer radius R, and thickness H that is rotated at an angular frequency co about its axis-of-rotation (axis-of-symmetry), for example the centrifugal pressure generated in the cylindrical drum 130 about its longitudinal axis 131, may be given by the following:

$${P}_{r} - {P}_{{R}_{0}} = {\int }_{{R}_{0}}^{r} ρ ( {ω}^{2} r ) r d r = \frac{1}{3} {ρω}^{2} ( {r}^{2} - {R}_{0}^{2} ) \qquad ( 10 )$$

where P_{R}_{₀} is the pressure in the rotating hollow tube (e.g., the inner cylindrical wall 136) located on the axis-of-rotation (axis-of-symmetry) and ρ is the mass density of the solution on the feed, concentrate or retentate side (e.g., feed-flow-region 139) of the flat sheet or hollow fibre membranes (e.g., membrane element 146, 246, 246a, 346, 346a). The pressure P_{R}_{₀} should at least be equal to the osmotic pressure corresponding to thermodynamic equilibrium between the feed and the permeate product, since no solvent permeation will occur at pressures less than this thermodynamic equilibrium pressure. However, it may be advantageous to introduce the feed at a pressure higher than the thermodynamic equilibrium pressure to reduce the diameter of the reverse osmosis apparatus 100, 200, 300 of the various embodiments required to create a centrifugal force equal to the pressure required for the desired permeate recovery and/or to decrease the SEC when an ERD is used to recover some of the pressure energy of the retentate.

For the process-design at the thermodynamic restriction the relationship between the local pressure Pᵣ and the concentrations on the high-pressure concentrate or retentate side (e.g., feed-flow-region 139) of the membranes (e.g., membrane element 146, 246, 246a, 346, 346a) depends on the particular solute. Consider as an example of the reverse osmosis apparatus 100, 200, 300 of the various embodiments, the desalination of a saline water feed. For saline water the local pressure Pᵣ and the concentrations on the high-pressure side (e.g., feed-flow-region 139) of the membranes (e.g., membrane element 146, 246, 246a, 346, 346a) is given by the following:

Pᵣ=K(Cₕ−Cₗ) (11)

where K=0.801 L·bar/g=0.0223 kWh·L/m³g.

Combine Equations (3), (10) and (11) to obtain an equation for Cₕ, the solute (e.g., salt) concentration on the high-pressure concentrate or retentate side (e.g., feed-flow-region 139) of the membranes (e.g., membrane element 146, 246, 246a, 346, 346a) at any radial position along the flat sheet or hollow fibre membranes (e.g. membrane element 146, 246, 246a, 346, 346a):

$${P}_{{R}_{0}} + \frac{1}{3} {ρω}^{2} ( {r}^{2} - {R}_{0}^{2} ) = K [ {C}_{h} - {C}_{h} ( 1 - σ ) ] = K σ {C}_{h} ⇒ {C}_{h} = \frac{{P}_{{R}_{0}} + \frac{1}{3} {ρω}^{2} ( {r}^{2} - {R}_{0}^{2} )}{K σ} \qquad ( 12 )$$

Combine Equations (3) and (12) to obtain an equation for Cₗ, the solute concentration on the low-pressure permeate side (e.g., permeate channel 138) of the membranes (e.g., membrane element 146, 246, 246a, 346, 346a) at any radial position along the flat sheet or hollow fibre membranes (e.g. membrane element 146, 246, 246a, 346, 346a):

$${C}_{l} = {C}_{h} ( 1 - σ ) ⇒ {C}_{l} = \frac{[ {P}_{{R}_{0}} + \frac{1}{3} ρ {ω}^{2} ( {r}^{2} - {R}_{0}^{2} ) ] ( 1 - σ )}{K σ} \qquad ( 13 )$$

Combine Equations (8) and (9) to eliminate Gₗ, the volumetric flowrate on the low-pressure permeate side (e.g., permeate channel 138) of the membranes (e.g., membrane element 146, 246, 246a, 346, 346a) to obtain an equation for Gₕ, the volumetric flowrate on the high-pressure concentrate or retentate side (e.g., feed-flow-region 139) of the membranes (e.g., membrane element 146, 246, 246a, 346, 346a):

$${C}_{h} {G}_{h} + {C}_{l} {G}_{l} = {C}_{f} {G}_{f} ⇒ {C}_{h} {G}_{h} + {C}_{l} ( {G}_{f} - {G}_{h} ) = {C}_{f} {G}_{f} ⇒ {G}_{h} = \frac{{G}_{f} ( {C}_{f} - {C}_{l} )}{{C}_{h} - {C}_{l}} \qquad ( 14 )$$

Combine Equations (8) and (14) to obtain an equation for Gₗ, the volumetric flowrate on the low-pressure permeate side (e.g., permeate channel 138) of the membranes (e.g., membrane element 146, 246, 246a, 346, 346a):

$${G}_{h} + {G}_{l} = {G}_{f} ⇒ {G}_{l} = {G}_{f} - {G}_{h} ⇒ {G}_{l} = {G}_{f} - \frac{{G}_{f} ( {C}_{f} - {C}_{l} )}{{C}_{h} - {C}_{l}} ⇒ {G}_{l} = \frac{{G}_{f} ( {C}_{h} - {C}_{f} )}{{C}_{h} - {C}_{l}} \qquad ( 15 )$$

Equations (12), (13), (14) and (15) may be used to determine the SEC, the energy required per unit volume of permeate product (e.g., potable water) to pump the feed solution (e.g., saline water) on the concentrate or retentate side (e.g., feed-flow-region 139) of the membranes (e.g., membrane element 146, 246, 246a, 346, 346a) to the pressure required for the desired permeate product recovery. This may be determined by considering the reverse osmosis apparatus 100, 200, 300 of the various embodiments to be a series of SSRO stages, each of which has a differential or infinitesimal length dr, connected in series such that the concentrate or retentate from the high-pressure side (e.g., feed-flow-region 139) of one stage serves as the feed to the next stage that is at a differentially or infinitesimally higher pressure. The permeate from the low-pressure side (e.g., permeate channel 138) of each stage may be combined with the permeate from all the differential or infinitesimal stages that constitutes the permeate product (e.g., potable water). The differential or infinitesimal energy consumption may be equal to the product of the differential or infinitesimal increase in pressure dP from r−Δr to r and Gₕ|ᵣ the volumetric flowrate on the high-pressure or concentrate or retentate side (e.g., feed-flow-region 139) of the membranes (e.g., membrane element 146, 246, 246a, 346, 346a) evaluated at the radial position r. The differential or infinitesimal energy consumption then may be determined from Equations (10) and (14) and may be given by the following:

$${G}_{h} {\vert}_{r} \times d P = \frac{{G}_{f} ( {C}_{f} - {C}_{l} )}{{C}_{h} - {C}_{l}} d [ {P}_{{R}_{0}} + \frac{1}{3} ρ {ω}^{2} ( {r}^{2} - {R}_{0}^{2} ) ] = \frac{{G}_{f} ( {C}_{f} - {C}_{l} )}{{C}_{h} - {C}_{l}} \frac{2 ρ {ω}^{2}}{3} r d r \qquad ( 16 )$$

Equations (12) and (13) for Cₕ and Cₗ, respectively, may be substituted into Eq. (16) and the result integrated numerically to obtain the SEC. However, Equation (16) may be integrated exactly in closed form if the assumption is made that the solute rejection σ≅1, since this implies that Cₗ<<Cₕ and Cₗ<<Cₕ. This is a reasonable assumption for applications such as water desalination, since commercial membranes have a salt rejection σ>0.99. Hence, Equation (16) simplifies to the following:

$${G}_{h} {\vert}_{r} \times d P = \frac{2}{3} {ρω}^{2} \frac{{G}_{f} {C}_{f}}{{C}_{h}} r d r \qquad ( 17 )$$

Substitute Equation (12) into Equations (17) assuming that σ≅1 to obtain the following:

$${G}_{h} {\vert}_{r} \times d P = \frac{2}{3} \frac{K ρ {ω}^{2} {G}_{f} {C}_{f} r d r}{{P}_{{R}_{0}} + \frac{1}{3} {ρω}^{2} ( {r}^{2} - {R}_{0}^{2} )} \qquad ( 18 )$$

Equation (18) may be cast into the form of an exact differential that may be integrated in closed form to obtain the following equation for the energy required to raise the pressure on the high-pressure concentrate or retentate side (e.g., feed-flow-region 139) of the membranes (e.g., membrane element 146, 246, 246a, 346, 346a) from P_{R}_{₀} to P_{R}:

$${\int }_{{R}_{0}}^{R} {G}_{h} {\vert}_{r} \times d P = K {G}_{f} {C}_{f} {ln [ {P}_{{R}_{0}} + \frac{1}{3} {ρω}^{2} ( {r}^{2} - {R}_{0}^{2} ) ]}_{{R}_{0}}^{R} = K {G}_{f} {C}_{f} ln [ \frac{{P}_{{R}_{0}} + \frac{1}{3} {ρω}^{2} ( {R}^{2} - {R}_{0}^{2} )}{{P}_{{R}_{0}}} ] \qquad ( 19 )$$

The gross specific energy consumption SEC_{gross} is the sum of the energy required to raise the pressure of the saline water feed to P_{R}_{₀} via a conventional high-pressure pump plus the energy required to raise the pressure on the high-pressure concentrate or retentate side (e.g., feed-flow-region 139) of the membranes (e.g., membrane element 146, 246, 246a, 346, 346a) via centrifugal acceleration from P_{R}_{₀} to P_{R} given by Equation (19) divided by the volumetric flowrate of the permeate product emanating from the low-pressure permeate side (e.g., permeate channel 138) of the membranes (e.g., membrane element 146, 246, 246a, 346, 346a) given by Equation (15) evaluated at r=R:

$$S E {C}_{gross} = \frac{{P}_{{R}_{0}} {G}_{f}}{{η}_{P} {G}_{l} {\vert}_{R}} + \frac{K {C}_{f}}{{G}_{l} {\vert}_{R}} ln [ \frac{{P}_{{R}_{0}} + \frac{1}{3} {ρω}^{2} ( {R}^{2} - {R}_{0}^{2} )}{{P}_{{R}_{0}}} ] \qquad ( 20 )$$

$$where$$

$${G}_{l} {\vert}_{R} = \frac{{G}_{f} ( {C}_{h} - {C}_{f} )}{{C}_{h}} {\vert}_{R} \qquad ( 21 )$$

$$and$$

$${C}_{h} {\vert}_{R} = \frac{{P}_{{R}_{0}} + \frac{1}{3} {ρω}^{2} ( {R}^{2} - {R}_{0}^{2} )}{K} \qquad ( 22 )$$

and η_{P} is the efficiency for both the pump required to pre-pressurize the feed via a conventional high-pressure pump and for the generation of the centrifugal force required to raise the pressure on the retentate side (e.g., feed-flow-region 139) of the membranes (e.g., membrane element 146, 246, 246a, 346, 346a) from P_{R}_{₀} to P_{R}.

The fractional total permeate product recovery Y may be given by the following:

$$Y = \frac{{G}_{l} {\vert}_{R}}{{G}_{f}} \qquad ( 24 )$$

where Gₗ|ᵣ is the volumetric flowrate out of the reverse osmosis apparatus 100, 200, 300 of the various embodiments on the low-pressure permeate side (e.g., feed-flow-region 139) of the membranes (e.g., membrane element 146, 246, 246a, 346, 346a) given by Equation (21).

Note if the membranes (e.g., membrane element 146, 246, 246a, 346, 346a) extend from near the longitudinal axis 131 of the cylindrical drum 130 (or the axis-of-rotation or axis-of-symmetry) to the outer radius of the cylindrical drum 130 (or rotating device), R₀<<R and Equation (10) evaluated at the outer radius R simplifies to the following:

$${P}_{R} - {P}_{{R}_{0}} = \frac{1}{3} ρ {ω}^{2} ( {R}^{2} - {R}_{0}^{2} ) ≅ \frac{1}{3} {ρ ( ω R )}^{2} \qquad ( 26 )$$

Substituting Equation (26) into Equation (20) then yields the following equation for the SEC_{gross} of the reverse osmosis apparatus 100, 200, 300 of the various embodiments:

$$S E {C}_{gross} = \frac{{P}_{{R}_{0}} {G}_{f}}{{η}_{P} {G}_{l} {\vert}_{R}} + \frac{K {C}_{f}}{{G}_{l} {\vert}_{R}} ln [ \frac{{ρ ( ω R )}^{2}}{3 {P}_{{R}_{0}}} ] \qquad ( 27 )$$

If an ERD is used to recover the pressure energy of the retentate, the required pumping energy may be reduced. The net specific energy consumption SECₙₑₜ when an ERD is used may be given by the following:

$$S E {C}_{n e t} = S E {C}_{g r o s s} - \frac{{η}_{ERD} {P}_{R} {G}_{h} {\vert}_{R}}{{G}_{l} {\vert}_{R}} \qquad ( 28 )$$

where η_{ERD} is the efficiency of the ERD.

Equation (26) indicates that the centrifugal pressure required to achieve a desired water recovery may be achieved either by increasing the angular rotation rate co or by increasing the radius R of the reverse osmosis apparatus 100, 200, 300 of the various embodiments. There is an optimum choice of the angular rotation rate and radius dictated by minimizing the total cost of water production.

FIG. 5 shows the required pressure difference between the feed and retentate discharge as a function of the fractional total water recovery for a typical seawater feed containing 35 g/L of salt. The dotted lines show that a reverse osmosis apparatus according to the various embodiments (denoted as CRO, centrifugal reverse osmosis, in FIG. 5) having a radius of 0.88 m rotating at 1000 rpm may achieve a 50% water recovery.

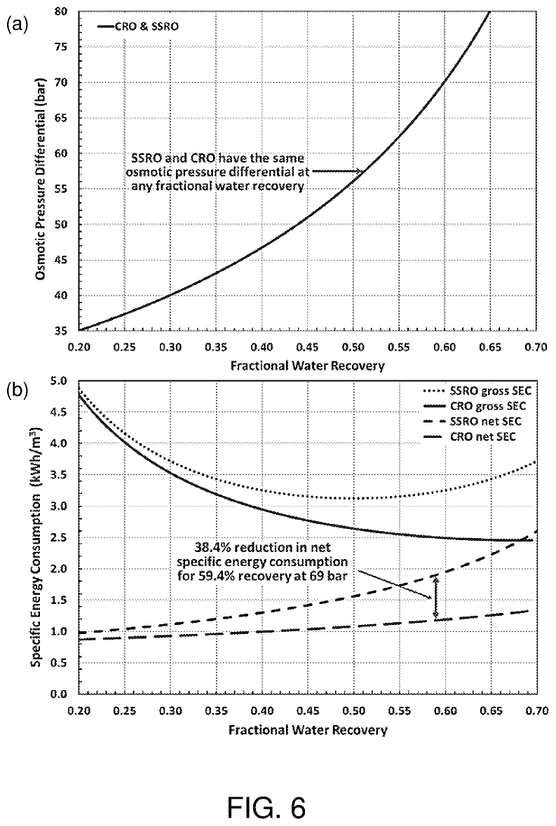

FIG. 6 to FIG. 8 compare the performance metrics of the reverse osmosis apparatus according to the various embodiments (or CRO) with those for conventional SSRO assuming 100% efficient pumps and a 100% efficient ERD. FIG. 6 shows (a) the osmotic pressure differential or infinitesimal (OPD) and (b) SEC, respectively, as a function of the fractional total water product recovery for a typical seawater feed containing 35 g/L of salt. FIG. 6 indicates in (a) that both the reverse osmosis apparatus according to the various embodiments (or CRO) and conventional SSRO require the same OPD to achieve a specified fractional total water recovery. FIG. 6 in (b) shows both the SEC_{gross} (without an ERD) and SECₙₑₜ (with an ERD) since an ERD usually is used for seawater desalination to recovery the pressure energy of the retentate brine discharge. FIG. 6 indicates in (b) that the reverse osmosis apparatus according to the various embodiments (or CRO) has a lower SEC_{gross} and SECₙₑₜ than conventional SSRO for all fractional water recoveries. For example, for a 0.594 fractional total water product recovery for which the required pressure is 69 bar, the maximum pressure sustainable by commercial reverse osmosis membranes, the reverse osmosis apparatus according to the various embodiments (or CRO) may reduce the SECₙₑₜ relative to conventional SSRO by 38.4%.

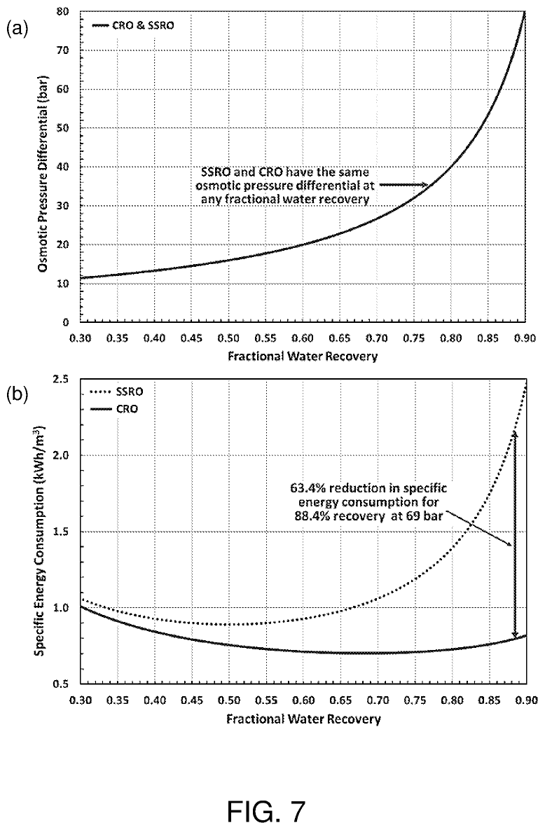

FIG. 7 shows (a) the OPD and (b) SEC, respectively, as a function of the fractional total water product recovery for a typical brackish water feed containing 10 g/L of salt. Note that it is not economic to use an ERD for less concentrated saline water feeds such as brackish water. Hence, the SEC shown in FIG. 7 is the SEC_{gross}. FIG. 7 indicates in (a) that both the reverse osmosis apparatus according to the various embodiments (or CRO) and conventional SSRO require the same OPD to achieve a specified fractional total water recovery. However, FIG. 7 indicates in (b) that the reverse osmosis apparatus according to the various embodiments (or CRO) may achieve any desired fractional total water product recovery at a substantially lower SEC than required for conventional SSRO. For example, for a 0.884 fractional total water product recovery for which the required pressure is 69 bar, the maximum pressure sustainable by commercial reverse osmosis membranes, the reverse osmosis apparatus according to the various embodiments (or CRO) may reduce the SEC relative to conventional SSRO by 63.4%.

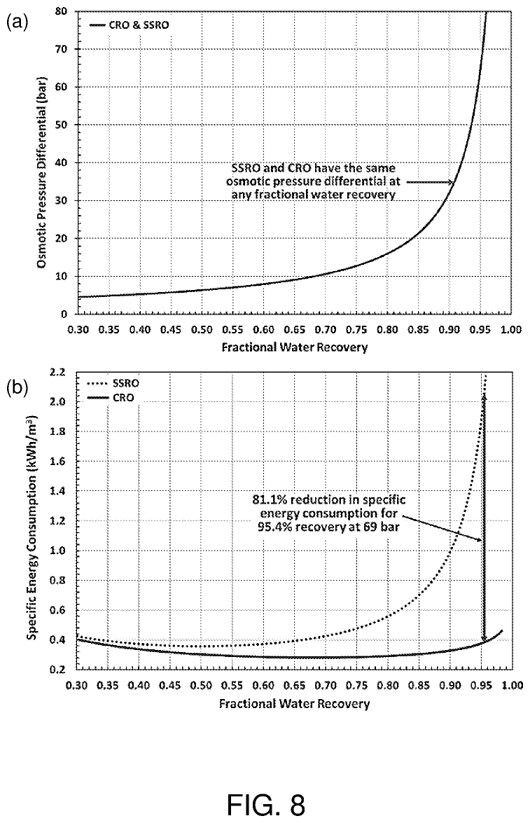

FIG. 8 shows (a) the OPD (upper panel) and (b) SEC (lower panel), respectively, as a function of the fractional total water product recovery for a typical inland saline water feed containing 4 g/L of salt. Since it is not economic to use an ERD for less concentrated saline water feeds such as inland water, the SEC shown in FIG. 8 is the SEC_{gross}. FIG. 8 indicates in (a) that both the reverse osmosis apparatus according to the various embodiments (or CRO) and conventional SSRO require the same OPD to achieve a specified fractional total water recovery. However, FIG. 8 indicates in (b) that the reverse osmosis apparatus according to the various embodiments (or CRO) may achieve any desired fractional total water product recovery at a substantially lower SEC than required for conventional SSRO. For example, for a 0.954 fractional total water product recovery for which the required pressure is 69 bar, the maximum pressure sustainable by commercial reverse osmosis membranes, the reverse osmosis apparatus according to the various embodiments (or CRO) may reduce the SEC relative to conventional SSRO by 81.1%.

According to various embodiments, there is provided a reverse osmosis device or apparatus (or CRO device) containing a parallel ‘sandwich’ of flat sheet membranes, feed channels with spacers, and permeate channels with spacers extending radially outward that rotates about an axis-of-rotation to cause a continuous differential or infinitesimal increase in the TMP with increasing radial distance from the axis-of-rotation.

According to various embodiments, there is provided a reverse osmosis device or apparatus (or CRO device) containing an array of hollow fibre membranes extending radially outward that rotates about an axis-of-rotation to cause a continuous differential or infinitesimal increase in the TMP with increasing radial distance from the axis-of-rotation.

According to various embodiments, there is provided a reverse osmosis device or apparatus (or CRO device) containing flat sheet or hollow fibre membranes extending radially outward that rotates about an axis-of-rotation to cause a local TMP on the membranes to be only differentially or infinitesimally larger than the TMP at thermodynamic equilibrium across the membranes at any radial distance from the axis-of-rotation.

According to various embodiments, there is provided a reverse osmosis device or apparatus (or CRO device) containing flat sheet or hollow fibre membranes extending radially outward that rotates about an axis-of-rotation for which the feed is pressurized to that corresponding to the thermodynamic equilibrium dictated by the concentration of the entering feed and the permeate prior to an additional progressive increase in pressure owing to the centrifugal acceleration.

According to various embodiments, there is provided a reverse osmosis device or apparatus (or CRO device) containing flat sheet or hollow fibre membranes extending radially outward that rotates about an axis-of-rotation for which the feed is pressurized to higher than that corresponding to the thermodynamic equilibrium dictated by the concentration of the entering feed and the permeate to decrease the size of the rotating device.

According to various embodiments, there is provided a reverse osmosis device or apparatus (or CRO device) containing flat sheet or hollow fibre membranes extending radially outward that rotates about an axis-of-rotation for which a back-pressure regulator is employed on the concentrate or retentate line from the rotating device to maintain the desired high pressure.

According to various embodiments, there is provided a reverse osmosis device or apparatus (or CRO device) containing flat sheet or hollow fibre membranes extending radially outward that rotates about an axis-of-rotation for which the permeate product is discharged at ambient pressure to maximize the TMP caused by the centrifugal pressure created on the concentrate or retentate side of the membranes.

According to various embodiments, there is provided a reverse osmosis device or apparatus (or CRO device) containing hollow fibre membranes extending radially outward that rotates about an axis-of-rotation that employs one or more annular manifolds that allow increasing the number of hollow fibre membranes leaving the manifold relative to the number of hollow fibre membranes entering the manifold.

According to various embodiments, there is provided a reverse osmosis device or apparatus (or CRO device) containing flat sheet or hollow fibre membranes extending radially outward that rotates about an axis-of-rotation that employs an ERD to recover some of the pressure energy of the high-pressure concentrate or retentate discharged from the rotating device.

According to various embodiments, there is provided a reverse osmosis device or apparatus (or CRO device) equipped with a series of nozzles attached to the lower part of the rotating assembly through which the high-pressure retentate is jetted to impinge on stationary vanes to impart a torque to rotate the device thereby serving as an ERD.

According to various embodiments, there is provided a reverse osmosis device or apparatus (or CRO device) containing flat sheet or hollow fibre membranes extending radially outward that rotates about an axis-of-rotation to reduce the SEC relative to that required for conventional SSRO for desalination of inland water feed solutions, brackish water feed solutions and seawater feed solutions.

According to various embodiments, there is provided a reverse osmosis device or apparatus (or CRO device) containing flat sheet or hollow fibre membranes extending radially outward that rotates about an axis-of-rotation to reduce the SEC relative to that required for conventional SSRO for concentrating the ethanol from aqueous ethanol feed solutions.

According to various embodiments, there is provided a reverse osmosis device or apparatus (or CRO device) containing flat sheet or hollow fibre membranes extending radially outward that rotates about an axis-of-rotation to reduce the SEC relative to that required for conventional SSRO for concentrating, separating or purifying solutions containing solutes that cause a significant osmotic pressure relative to the permeate product.

According to various embodiments, there is provided a multistage configuration including two or more reverse osmosis device or apparatus (or CRO device) of the various embodiments arranged so that the concentrate or retentate from one CRO device is further concentrated by sending it as the feed to a successive CRO device.

Various embodiments of the apparatus and the methods have employed rotation of an array of semi-permeable membranes about an axis-of-rotation to create a centrifugal force that increases differentially or infinitesimally with increasing radial distance from an axis-of-rotation, thereby providing a continuous increase in the transmembrane pressure (TMP) that causes permeation or reverse osmosis (RO) whereby a liquid containing salts or low molecular weight solutes is separated into a nearly pure liquid product. Representative applications may include the recovery at a reduced specific energy consumption (SEC) of potable water from saline water and the concentration of aqueous ethanol solutions emanating from biomass technologies.

Various embodiments may achieve reverse osmosis near the thermodynamic restriction and may offer the marked advantage of being a continuous process that may be adapted to small-scale decentralized brackish and inland water desalination facilities as well as to large-scale seawater desalination plants. Scale-up of various embodiments may also be achieved in the same way that it is done for conventional reverse membrane modules, namely by connecting reverse osmosis stages in parallel to handle the required volume of saltwater feed. Another advantage of the various embodiments is that the significantly higher water recoveries made economically feasible may reduce the pre- and post-treatment costs for reverse osmosis normalized with respect to the volume of freshwater produced. The more concentrated brine resulting from the higher recovery made possible by the various embodiments also may make the economics of pressure-retarded osmosis (PRO) for recovering the substantial osmotic potential energy of the brine more favourable. Various embodiments may also make recovering valuable solutes such as the alkali metals from the brine more economic; for example, extracting lithium that is used in batteries and rubidium that is used for photocells. Various embodiments may also be adapted to significantly reduce the energy costs for the reverse osmosis concentration of other low molecular weight solutes from aqueous solutions for which osmotic effects require high pressures; for example, recovering ethanol from aqueous solutions emanating from biomass processes. Various embodiments may also be a potentially transformative technology for significantly lowering the cost of desalination to meet the global challenge of providing potable water for all the people of this world and has the potential to lower the cost of renewable biofuels production.

While the invention has been particularly shown and described with reference to specific embodiments, it should be understood by those skilled in the art that various changes, modification, variation in form and detail may be made therein without departing from the scope of the invention as defined by the appended claims. The scope of the invention is thus indicated by the appended claims and all changes which come within the meaning and range of equivalency of the claims are therefore intended to be embraced.

1. A reverse osmosis apparatus comprising:
a reverse osmosis unit having
a housing,
a cylindrical drum disposed inside the housing and coupled to the housing in a manner so as to be rotatable relative to the housing about a longitudinal axis of the cylindrical drum, wherein a lateral gap between an exterior cylindrical surface of the cylindrical drum and the housing defines an intervening chamber, wherein the cylindrical drum comprises
an outer cylindrical wall defining an interior cylindrical space of the cylindrical drum, and
an inner cylindrical wall partitioning the interior cylindrical space into an inner cylindrical feed chamber encircled by the inner cylindrical wall and an outer annular separation chamber between the inner cylindrical wall and the outer cylindrical wall, and
at least one channeling structure extending radially from the inner cylindrical wall of the cylindrical drum to the outer cylindrical wall of the cylindrical drum and sub-dividing the outer annular separation chamber into at least a permeate channel and a feed-flow-region, the at least one channeling structure defining the permeate channel therewithin, wherein a first channel end of the at least one channeling structure at the inner cylindrical wall is closed to separate the permeate channel from the inner cylindrical feed chamber and a second channel end of the at least one channeling structure is opened through the outer cylindrical wall to open the permeate channel into the intervening chamber, wherein the inner cylindrical wall has an opening for direct fluid communication between the inner cylindrical feed chamber and the feed-flow-region of the outer annular separation chamber, wherein the at least one channeling structure comprises
a membrane element extending lengthwise along the at least one channeling structure from the inner cylindrical wall of the cylindrical drum to the outer cylindrical wall of the cylindrical drum, the membrane element being a semi-permeable interface between the permeate channel and the feed-flow-region of the outer annular separation chamber;
a pump in fluid communication with the inner cylindrical feed chamber of the cylindrical drum of the reverse osmosis unit, the pump operable to pressurize the inner cylindrical feed chamber to be equal to or higher than an osmotic pressure of a feed for reverse osmosis; and
a motor coupled to the cylindrical drum of the reverse osmosis unit, the motor operable to rotate the cylindrical drum so as to continuously increase, via a centrifugal force generated, a pressure of the feed in the feed-flow-region of the outer annular separation chamber along the membrane element with increasing distance from the inner cylindrical wall of the cylindrical drum to the outer cylindrical wall of the cylindrical drum.

2. The apparatus as claimed in claim 1, wherein a diameter of the outer cylindrical wall of the cylindrical drum is equal to or greater than two times a diameter of the inner cylindrical wall of the cylindrical drum.

3. The apparatus as claimed in claim 1, wherein the reverse osmosis unit comprises a permeate discharge port disposed at the housing in a manner so as to be in fluid communication with the intervening chamber for discharging a permeate product at ambient pressure.

4. The apparatus as claimed in claim 1, wherein the reverse osmosis unit comprises one or more retentate discharge nozzles disposed at a base of the cylindrical drum in a manner so as to be in fluid communication with the feed-flow-region of the outer annular separation chamber for discharging a retentate product.

5. The apparatus as claimed in claim 4, wherein the reverse osmosis unit comprises at least a back-pressure regulator coupled between the feed-flow-region of the outer annular separation chamber and the one or more retentate discharge nozzles.

6. The apparatus as claimed in claim 4, further comprising an energy recovery unit coupled to the reverse osmosis unit, the energy recovery unit comprising
a plurality of stationary vanes extending radially from a stationary hub, wherein the stationary hub is fixed with respect to the housing of the reverse osmosis unit,
wherein the base of the cylindrical drum of the reverse osmosis unit is rotatable relative to the stationary hub and the stationary hub is aligned to the longitudinal axis of the cylindrical drum, and
wherein the one or more retentate discharge nozzles is directed towards the plurality of vanes in a manner such that pressurized jets from the retentate discharge nozzles generate a torque at the base of the cylindrical drum to augment a rotation of the cylindrical drum.

7. The apparatus as claimed in claim 1, wherein the membrane element of the at least one channeling structure comprises an annular sector shaped membrane sheet, wherein an inner arc of the annular sector shaped membrane sheet is coupled to the inner cylindrical wall of the cylindrical drum and an outer arc of the annular sector shaped membrane sheet is coupled to the outer cylindrical wall of the cylindrical drum.

8. The apparatus as claimed in claim 7, wherein the at least one channeling structure comprises
two annular sector shaped membrane sheets in a stack arrangement one above the other, and
at least two strips of permeate channel spacers between the two annular sector shaped membrane sheets to space apart the two annular sector shaped membrane sheets, wherein the at least two strips of permeate channel spacers are respectively lined between two opposing pairs of straight sides of the two annular sector shaped membrane sheets in a manner such that a space enclosed by the two annular sector shaped membrane sheets and the at least two strips of permeate channel spacers defines the permeate channel.

9. The apparatus as claimed in claim 8, wherein a portion of the inner cylindrical wall of the cylindrical drum bordered around by inner arcs of the two annular sector shaped membrane sheets and inner ends of the at least two strips of permeate channel spacers is a solid portion to close the first channel end of the at least one channeling structure, and wherein a portion of the outer cylindrical wall of the cylindrical drum bordered around by outer arcs of the two annular sector shaped membrane sheets and outer ends of the at least two strips of permeate channel spacers comprises an opening to open the second channel end of the at least one channeling structure into the intervening chamber.

10. The apparatus as claimed in claim 9, comprising
at least two channeling structures in a stack arrangement one above the other, each channeling structure having an annular sector shape, and
at least two strips of feed-flow channel spacers between the at least two channeling structures to space apart the at least two channeling structures, wherein the at least two strips of feed-flow channel spacers are respectively lined along two opposing pairs of straight edges of the at least two channeling structures in a manner such that a space enclosed by the at least two shaped channeling structures and the at least two strips of feed-flow channel spacers defines the feed-flow region.

11. The apparatus as claimed in claim 10, wherein a portion of the inner cylindrical wall of the cylindrical drum bordered around by two opposing inner arc edges of the at least two channeling structures and inner ends of the at least two strips of feed-flow channel spacers comprises the opening for direct fluid communication between the inner cylindrical feed chamber and the feed-flow-region, and wherein a portion of the outer cylindrical wall of the cylindrical drum bordered around by two opposing outer arc edges of the at least two channeling structures and outer ends of the at least two strips of feed-flow channel spacers is a solid portion to separate the feed-flow region and the intervening chamber.

12. The apparatus as claimed in claim 11, wherein each of the at least two strips of feed-flow channel spacers comprises an opening at the outer end.

13. The apparatus as claimed in 12, comprising
at least two adjacent stacks of channeling structures, each stack having the at least two channeling structures having the annular sector shape in the stack arrangement,
wherein the at least two adjacent stacks of channeling structures are spaced angularly from each other with respect to the longitudinal axis of the cylindrical drum in a manner so as to form a vertical retentate channel parallel to the longitudinal axis of the cylindrical drum,
wherein the openings at the outer ends of the at least two strips of feed-flow channel spacers open the feed-flow region for direct fluid communication with the vertical retentate channel.

14. The apparatus as claimed in claim 1, wherein the at least one channeling structure comprises
a hollow fibre membrane as the membrane element,
wherein an inner end of the hollow fibre membrane is coupled to the inner cylindrical wall of the cylindrical drum and an outer end of the hollow fibre membrane is coupled to the outer cylindrical wall of the cylindrical drum,
wherein a lumen of the hollow fibre membrane defines the permeate channel,
wherein a portion of the inner cylindrical wall of the cylindrical drum encircled by an orifice of the inner end of the hollow fibre membrane is a solid portion to close the first channel end of the at least one channeling structure, and wherein a portion of the outer cylindrical wall of the cylindrical drum encircled by an orifice of the outer end of the hollow fibre membrane comprises an opening to open the second channel end of the at least one channeling structure into the intervening chamber.

15. The apparatus as claimed in claim 14, wherein the cylindrical drum further comprises an annular frame disposed inside the outer separation chamber to surround the inner cylindrical wall in a concentric manner with a first annular space between the inner cylindrical wall and the annular frame and a second annular space between the annular frame and the outer cylindrical wall, wherein the hollow fibre membrane extending between the inner cylindrical wall and the outer cylindrical wall extends through the annular frame.

16. The apparatus as claimed in claim 15, further comprising at least one secondary channeling structure, the at least one secondary channeling structure comprises
a secondary hollow fibre membrane,
wherein an inner end of the secondary hollow fibre membrane is coupled to the annular frame and an outer end of the secondary hollow fibre membrane is coupled to the outer cylindrical wall of the cylindrical drum,
wherein a lumen of the secondary hollow fibre membrane defines a secondary permeate channel,
wherein a portion of the annular frame encircled by an orifice of the inner end of the secondary hollow fibre membrane is a solid portion to close a first channel end of the at least one secondary channeling structure, and wherein a portion of the outer cylindrical wall of the cylindrical drum encircled by an orifice of the outer end of the secondary hollow fibre membrane comprises an opening to open a second channel end of the at least one secondary channeling structure into the intervening chamber.

17. A reverse osmosis method of separating a solvent from a feed, the method comprising
filling a cylindrical drum of a reverse osmosis unit of a reverse osmosis apparatus with the feed in a manner such that an inner cylindrical feed chamber of the cylindrical drum and a feed-flow-region of an outer annular separation chamber of the cylindrical drum is filled up with the feed, wherein the reverse osmosis unit comprises
a housing,
the cylindrical drum disposed inside the housing and coupled to the housing in a manner so as to be rotatable relative to the housing about a longitudinal axis of the cylindrical drum, wherein a lateral gap between an exterior cylindrical surface of the cylindrical drum and the housing defines an intervening chamber, wherein the cylindrical drum comprises
an outer cylindrical wall defining an interior cylindrical space of the cylindrical drum, and
an inner cylindrical wall partitioning the interior cylindrical space into the inner cylindrical feed chamber encircled by the inner cylindrical wall and the outer annular separation chamber between the inner cylindrical wall and the outer cylindrical wall, and
at least one channeling structure extending radially from the inner cylindrical wall of the cylindrical drum to the outer cylindrical wall of the cylindrical drum and sub-dividing the outer annular separation chamber into at least a permeate channel and the feed-flow-region, the at least one channeling structure defining the permeate channel therewithin, wherein a first channel end of the at least one channeling structure at the inner cylindrical wall is closed to separate the permeate channel from the inner cylindrical feed chamber and a second channel end of the at least one channeling structure is opened through the outer cylindrical wall to open the permeate channel into the intervening chamber, wherein the inner cylindrical wall has an opening for direct fluid communication between the inner cylindrical feed chamber and the feed-flow-region of the outer annular separation chamber, wherein the at least one channeling structure comprises
a membrane element extending lengthwise along the at least one channeling structure from the inner cylindrical wall of the cylindrical drum to the outer cylindrical wall of the cylindrical drum, the membrane element being a semi-permeable interface between the permeate channel and the feed-flow-region of the outer annular separation chamber;
pressurizing, via a pump of the reverse osmosis apparatus in fluid communication with the inner cylindrical feed chamber of the cylindrical drum, the feed in the inner cylindrical feed chamber of the cylindrical drum and the feed-flow-region of the outer annular separation chamber of the cylindrical drum to be equal to or higher than an osmotic pressure of the feed for reverse osmosis; and
rotating the cylindrical drum relative to the housing, via a motor of the reverse osmosis apparatus coupled to the cylindrical drum, to continuously increase, via a centrifugal force generated, a pressure of the feed in the feed-flow-region of the outer annular separation chamber along the membrane element with increasing distance from the inner cylindrical wall of the cylindrical drum to the outer cylindrical wall of the cylindrical drum.

18. The method as claimed in claim 17, further comprising discharging a permeate product containing the solvent at ambient pressure via a permeate discharge port disposed at the housing and in fluid communication with the intervening chamber.

19. The method as claimed in claim 17, further comprising maintaining the pressure of the feed in the feed-flow-region of the outer annular separation chamber via at least a back-pressure regulator of the reverse osmosis unit coupled between the feed-flow-region of the outer annular separation chamber and one or more retentate discharge nozzles disposed at a base of the cylindrical drum.

20. The method as claimed in claim 17, further comprising discharging a retentate product from the feed-flow-region of the outer annular separation chamber towards a plurality of stationary vanes extending radially from a hub fixed with respect to the housing and aligned to the longitudinal axis of the cylindrical drum so as to recover a pressure energy from the retentate product to augment the motor for rotating the cylindrical drum.
